(19) United States
(12) Patent Application Publication
(10) Pub. No.: US 2006/0067231 A1
(43) Pub. Date: Mar. 30, 2006

(54) Packet reception control device and method

(75) Inventors: Tatsuro Ikoma, Osaka (JP); Masaaki Tamai, Osaka (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/232,905

(22) Filed: Sep. 23, 2005

(30) Foreign Application Priority Data
Sep. 27, 2004 (JP) 2004-279981
Sep. 12, 2005 (JP) 2005-264201

(51) Int. Cl. H04L 12/26

(52) U.S. Cl. 370/235; 370/217

(57) ABSTRACT

The packet reception control device includes: a load detection section for detecting a load on a processor and outputting the detection result; and a reception control section for determining whether or not the processor should receive a reception packet based on the detection result output from the load detection section and outputting the determination result. The processor receives the reception packet according to the determination result output from the reception control section.

### CROSS-REFERENCE TO RELATED APPLICATIONS

This application claims priority under 35 U.S.C. § 119 on Patent Applications No. 2004-279981 filed in Japan on Sep. 27, 2004 and No. 2005-264201 filed in Japan on Sep. 12, 2005, the entire contents of which are hereby incorporated by reference.

### BACKGROUND OF THE INVENTION

The present invention relates to a technology of controlling reception of packets from a network.

The tendency of adding the function of establishing connection with a network such as the Internet to conventionally existing equipment is increasing year by year. With this tendency, there have emerged problems occurring in adding the network interface function to conventional equipment designs.

A representative example of networks is Ethernet conforming to the Institute of Electrical and Electronics Engineers (IEEE) 802.3. The Ethernet is a packet transmission/reception network, in which it is essentially impossible to predict or guarantee coming reception packets.

For example, in one situation, some apparatus may be connected to a network and a large amount of packets may be produced under multicasting or broadcasting originating from or directed to the apparatus. In another situation, traffic for jeopardizing security such as port scan, denial of service attack and computer virus may arise causing coming of a large amount of unpredictable packets.

In the situations described above, if equipment faces coming of reception packets of an amount exceeding the ability of the equipment, the processor of the equipment is likely to fall in an overload state devoting most of its processing power to processing of the reception packets. As a result, the equipment may be blocked in implementing its original functions.

For example, when equipment is to perform communications processing requiring real-time capabilities such as audio-visual (AV) functions, higher priority is generally given to the communications processing than to other processing items. Accordingly, with coming of a large amount of reception packets, the processor of the equipment will devote majority of its ability to the communications processing. As a result, a delay may occur even in such a level of processing as detecting depression of a button, for example.

As technologies addressing the problem described above, the following are known, for example. Japanese Laid-Open Patent Publication No. 9-116731 (Literature 1) discloses a facsimile machine provided with a function of detecting a system load. This facsimile machine performs data transfer processing at highest speed if the system load does not exceed a predetermined threshold, but lowers the data transfer rate if the system load becomes heavy due to simultaneous execution of communications processing and recording processing or any other reason. By this distribution of the system load, efficient data transfer is attained.

Japanese Laid-Open Patent Publication No. 11-328068 (Literature 2) discloses a system for network incorporation. FIG. 23 is a block diagram of the conventional system for network incorporation described in Literature 2. A plurality of applications 94 are connected to a network interface chip (NIC) driver 92 via a protocol stack 93.

The protocol stack 93 provides the function of communications with endpoint nodes that perform communications using the NIC driver 92. Each of the applications 94 is composed of a computer program providing a higher communications function using the protocol stack 93. A memory 96, accessed from both an NIC 91 and a printer controller 95, has an operation reduce flag holder 97.

When recognizing a start of emergency processing, the system of FIG. 23 sets a flag in the operation reduce flag holder 97 ON. During the time in which the operation reduce flag is ON, the NIC driver 92 drives the NIC 91 to execute filtering to stop reception of a specific type of packets among packets received in normal operation. In this way, the central processing unit (CPU) is relieved of processing unnecessary reception packets during the emergency operation.

However, the above technologies have the following problems. The technology disclosed in Literature 1 is based on the precondition that issuance of a command can be stopped or a notification of issuance of a command can be delayed in cooperation with a specific command issuing source. In the case of use of a packet communications network such as Ethernet, however, it is not necessarily possible to ask a producing source of packets that cause an increase of the load on a system receiving the packets to stop the production of packets or reduce the communications speed. Such a packet producing source may not even have an intention of using the system in the first place.

The technology disclosed in Literature 2 is meant for lightening the load caused by reception packets during the previously fixed time period of emergency processing. Such measures are not available during the other time periods. In a system actually operating under a multitask OS, even a program corresponding to emergency processing is required to operate intermittently. It is therefore difficult to fix such a time period of emergency processing.

### SUMMARY OF THE INVENTION

An object of the present invention is providing a packet reception control device and method in which an overload state of an apparatus receiving packets caused by coming of an excessively large amount of reception packets can be improved and the functions of the apparatus other than the packet reception function can be maintained.

The packet reception control device of the present invention include: a load detection section for detecting a load on a processor and outputting the detection result; and a reception control section for determining whether or not the processor should receive a reception packet based on the detection result from the load detection section and outputting the determination result, wherein the processor receives the reception packet according to the determination result from the reception control section.

According to the invention described above, the processor receives packets according to the result of the determination on whether or not the packets should be received. Therefore, an overload state of the processor caused by packet reception can be improved, and thus the processor is ensured to execute processing other than the packet reception.

Preferably, the packet reception control device described above further includes a reception packet transfer section for receiving a packet and outputting the received packet to the processor according to an instruction, wherein the load detection section detects a value corresponding to the degree of the load as a processing load, and the reception control section stores therein one or more filter rules set according to the processing load, and instructs the reception packet transfer section to discard a reception packet matching any of the filter rules and output a reception packet matching none of the filter rules.

According to the invention described above, a filter rule is set according to the processing load detected by the load detection section. Therefore, an appropriate filtering effect responsive to a change in processing load can be given to reception packets.

Preferably, the reception control section stores therein a rule set so that more reception packets match the rule as the processing load is larger, as the filter rule.

According to the invention described above, a greater filtering effect can be provided with increase of the processing load.

Preferably, the reception control section includes a statistic acquisition portion for classifying reception packets into a plurality of types and measuring a packet reception frequency per unit time for each type, and stores therein a rule set so that reception packets of types selected in descending order of the reception frequency per unit time, among the plurality of types, match the rule, as the filter rule.

According to the invention described above, the filtering effect can be provided by narrowing the target to reception packets responsible for a load on the processor according to the statistic nature of reception packets.

Preferably, the reception control section stores therein a rule set so that reception packets of a specific type do not match the rule, as the filter rule.

According to the invention described above, important reception packets can be excluded from the filtering target even if these packets are responsible for a large processing load. For example, it is possible to set so that packets indispensable for operation of equipment be received without fail.

Preferably, the reception control section stores therein a rule set so that broadcast packets and multicast packets match the rule if the processing load exceeds a predetermined threshold, as the filter rule.

According to the invention described above, all of broadcast and multicast reception packets are designated as the filtering target. Therefore, a great filtering effect can be expected.

Preferably, the reception control section stores therein a rule set so that all packets match the rule if the processing load exceeds a predetermined threshold, as the filter rule.

According to the invention described above, all received packets are designated as the filtering target. Therefore, the load on the processor can be greatly reduced.

Preferably, when the processing load decreases, the reception control section does not change the filter rule for a predetermined time period after the decrease, and stores therein a rule set in correspondence with the processing load as the filter rule after a lapse of the predetermined time period.

According to the invention described above, the filter rule for use at overloading can be maintained for a predetermined time period after a decrease in processing load. Therefore, an unduly sensitive response to a variation in processing load can be suppressed.

Preferably, the packet reception control device described above further includes a discard counting portion for measuring the frequency of discarding of reception packets by the reception control section per unit time, wherein, when the processing load decreases, the reception control section does not change the filter rule if the frequency of discarding is equal to or more than a predetermined threshold, and stores therein information set in correspondence with the processing load as the filter rule information if the frequency of discarding becomes less than the predetermined threshold.

According to the invention described above, the filter rule for use at overloading is canceled only after confirmation of a decrease in the number of reception packets discarded. Therefore, the filter rule for use at overloading can be maintained as long as an overload may occur.

Preferably, the load detection section detects a value corresponding to the degree of the load as a processing load, and when the reception control section receives an event signal generated in relation to reception of a packet, the reception control section outputs a notification signal notifying the processor of the reception of the event signal so that the processor receive the reception packet if the processing load does not exceed a predetermined value, and stops the output of the notification signal if the processing load exceeds the predetermined value.

According to the invention described above, if the processing load exceeds a predetermined value, any notification on packet reception is prohibited. Therefore, the processor is ensured to execute processing other than the packet reception.

Preferably, the notification signal is an interrupt signal for the processor.

According to the invention described above, any interrupt with a notification signal related to packet reception is prohibited. Therefore, the processor is relieved of interrupt handling for receiving a packet.

Preferably, the reception control section measures the time elapsed from the stop of the output of the notification signal, and cancels the stop of the output of the notification signal if the measured lapse time exceeds a predetermined value.

According to the invention described above, it is possible to set so that the setting of prohibiting notification to the processor be maintained for a predetermined time period and thereafter normal operation be restored automatically.

Preferably, the reception control section measures the frequency of generation of the event signal per unit time, and cancels the stop of the output of the notification signal if the frequency of generation becomes smaller than a predetermined value after the stop of the output of the notification signal.

According to the invention described above, the stop of the output of the notification signal is canceled only after confirmation of a decrease in the number of event signals. Therefore, it is possible to set so that the stop of the output of the notification signal be maintained as long as an overload may occur and thereafter normal operation be restored automatically.

Preferably, the load detection section detects a value corresponding to the degree of the load as a processing load, and the load detection section includes: a timer counter for measuring the time elapsed from a startup; a monitoring portion for reading and outputting a count value of the timer counter when being accessed from the processor, and restarting the timer counter; a load computation portion for computing the processing load based on a predetermined planned value and the read count value, and outputting the resultant processing load.

According to the invention described above, the processing load is computed from the count value of the timer counter and the planned value. Therefore, the processing load can be expressed as a numerical value independent of the natures of the processor and the program.

Preferably, the monitoring portion is accessed by a task started periodically on a multitask operating system (OS) by the processor.

According to the invention described above, the load detection section can detect a processing load caused by a task on a multitask OS.

Preferably, the load detection section detects a value corresponding to the degree of the load as a processing load, and the load detection section includes: a timer counter for measuring the time elapsed from input of a clear signal and outputting a timeout signal once the measured time reaches a predetermined time; a monitoring portion for outputting the clear signal to the timer counter when being accessed from the processor; a load computation portion for computing the processing load based on the timeout signal.

According to the invention described above, since the timeout signal is output when the load on the processor is large, the processing load can be obtained based on the timeout signal.

Preferably, the load computation portion computes a value corresponding to the frequency of generation of the timeout signal per unit time as the processing load.

According to the invention described above, since the processing load is computed from the frequency of occurrence of timeout, a processing load averaged in each unit time can be obtained.

Preferably, the load computation portion computes a value corresponding to the number of times of consecutive output of the timeout signal as the processing load.

According to the invention described above, the maximum processing load in a time shorter than the unit time, for example, can be obtained.

Preferably, a larger value is set as the predetermined time when the timer counter went to timeout, and a smaller value is set when the timer counter was cleared.

According to the invention described above, the variation in processing load can be made mild.

Preferably, the monitoring portion is accessed by a task started periodically on a multitask OS by the processor.

Preferably, the packet reception control device described above further includes a reception packet transfer section for receiving a packet and outputting the received packet to the processor according to an instruction, wherein the load detection section detects whether or not the processor is in an overload state and outputs the detection result, and the reception control section stores therein one or more set filter rules, instructs the reception packet transfer section to discard a reception packet matching any of the filter rules and output a reception packet matching none of the filter rules, and when the processor is in an overload state, stores therein a filter rule for use at overloading that allows more packets than in the normal times to match, as the filter rule.

According to the invention described above, an overload state of the processor can be detected in a simple way, and the filter rule can be swiftly switched to one for use at overloading.

Preferably, the packet reception control device described above further include an overload remedy section, wherein the reception packet transfer section notifies the processor of output of a packet, the overload remedy section determines the frequency of the notification to the processor per unit time, and when the load detection section detects that the processor is in an overload state, notifies the reception control section that the processor is in an overload state if the frequency of the notification is equal to or more than a predetermined value, and the reception control section stores therein the filter rule for use at overloading, as the filter rule.

According to the invention described above, when the processor is in an overload state due to packet reception, the filter rule can be switched swiftly to one for use at overloading.

Preferably, when the processor goes to a non-overload state from an overload state, the overload remedy section notifies the reception control section that the processor is not in an overload state after a predetermined condition is satisfied, and the reception control section stores therein a filter rule for use in normal times as the filter rule when receiving the notification that the processor is not in an overload state.

According to the invention described above, it is possible to set so that the filter rule for use at overloading be maintained until a predetermined condition is satisfied and thereafter normal operation be restored automatically.

Preferably, the predetermined condition is that a predetermined time elapses from the time at which the processor is no more in an overload state.

According to the invention described above, it is possible to set so that the filter rule for use at overloading be maintained until a predetermined time has elapsed and thereafter normal operation be restored automatically.

Preferably, the packet reception control device described above further includes a discard counting portion for measuring the frequency of discarding of reception packets by the reception control section per unit time, wherein the predetermined condition is that the frequency of discarding is smaller than a predetermined value.

According to the invention described above, the setting for use at overloading is canceled only after it is confirmed that the frequency of discarding of reception packets is less than a predetermined value. Therefore, it is possible to set so that the filter rule for use at overloading be maintained as long as an overload may occur and thereafter normal operation be restored automatically.

Preferably, the filter rule for use at overloading is set to allow all packets to match.

According to the invention described above, all received packets are discarded at the time of overloading. Therefore, the load on the processor can be directly minimized.

Preferably, the reception control section further includes a statistic acquisition portion for classifying reception packets into a plurality of types and measuring a packet reception frequency per unit time for each type, and the filter rule for use at overloading is set so that reception packets of types selected in descending order of the reception frequency per unit time, among the plurality of types, match the rule.

According to the invention described above, the filtering effect can be obtained by narrowing the target to reception packets responsible for a load on the processor according to the statistic nature of the received packets.

Preferably, the filter rule for use at overloading is set so that reception packets of a specific type do not match the rule.

According to the invention described above, important reception packets can be excluded from the filtering target even if these packets are responsible for a large processing load.

Preferably, the load detection section detects whether or not the processor is in an overload state and outputs the detection result, and the reception control section determines the frequency of generation of an event signal generated in relation to packet reception per unit time, and can output a notification signal notifying the processor of reception of the event signal, the reception control section stopping the output of the notification signal if the processor is in an overload state and the frequency of generation of the event signal exceeds a predetermined value.

According to the invention described above, an overload state of the processor can be detected in a simple way, and the output of the notification signal related to packet reception is stopped if the frequency of generation of the event signal is high. Therefore, receiving no packets, the processor is ensured to execute processing other than the packet reception.

Preferably, the notification signal is an interrupt signal for the processor.

Preferably, the reception control section measures the lapse time from the stop of the output of the notification signal, and cancels the stop of the output of the notification signal when the measured lapse time exceeds a predetermined value.

Preferably, the reception control section measures the frequency of generation of the event signal per unit time, and cancels the stop of the output of the notification signal when the frequency becomes smaller than a predetermined value after the stop of the output of the notification signal.

Preferably, the packet reception control device described above further includes a watchdog timer for outputting an initialization request signal to the processor when no access is made from the processor within a predetermined time, and the reception control section stops the output of the notification signal when the remaining time before the watchdog timer outputs the initialization request signal is shorter than a predetermined time.

According to the invention described above, the output of the notification signal related to packet reception is stopped before the watchdog timer goes to timeout. This can avoid such a trouble that the processor fails to access the watchdog timer due to the processing of packet reception preventing the watchdog timer from performing normal monitoring operation.

Preferably, the load detection section includes: a timer counter for measuring the time elapsed from input of a clear signal and outputting a timeout signal indicating that the measured time reaches a predetermined time as the detection result; and a monitoring portion for outputting the clear signal to the timer counter when being accessed from the processor.

According to the invention described above, a signal indicating whether or not the processor is in an overload state can be obtained as the detection result from the load detection section.

Preferably, the timer counter is configured to allow change of the predetermined time.

According to the invention described above, the sensitivity of detection of an overload state can be adjusted by changing the ratio of the time elapsed until output of the timeout signal to the period of access to the monitoring section.

Preferably, the monitoring portion is accessed by a task started periodically on a multitask OS by the processor.

Preferably, the schedule priority of the task started periodically is set lower than the schedule priorities of processing tasks for packet communications protocols and processing tasks for real-time communications applications.

According to the invention described above, the monitoring portion can detect whether or not the processor is in an overload state due to processing tasks for packet communications protocols and processing tasks for real-time communications applications.

Preferably, the schedule priority of the task started periodically is set lower than the schedule priority of processing tasks for real-time control applications.

According to the invention described above, the monitoring portion can detect whether or not the processor is in an overload state due to processing tasks for packet communications protocols, processing tasks for real-time communications applications and processing tasks for real-time control applications.

Preferably, the schedule priority of the task started periodically is set higher than the schedule priority of processing tasks for applications requiring no real-time operation.

According to the invention described above, the monitoring portion can detect whether or not the processor is in an overload state due to causes other than processing tasks for applications requiring no real-time operation.

Preferably, the packet reception control device described above further includes: a reception packet transfer section for receiving a packet and storing the received packet in a memory according to an instruction, to be ready for output to the processor; and a packet analysis section for scanning information on reception packets that have been stored in the memory and determining frequency information indicating the reception frequency of the reception packets for each type, wherein the load detection section detects whether or not the processor is in an overload state and outputs the detection result, the reception control section includes: a discard filter table storage for storing filter rules; a filter rule setting portion for storing a first filter rule set in the discard filter table storage when receiving the detection result indicating that the processor is in an overload state, the first filter rule set including a filter rule indicating that a predetermined type of packets should be discarded; and a discard/pass determination portion for instructing the reception packet transfer portion to discard a reception packet matching any of the filter rules and output a reception packet matching none of the filter rules to the processor via the memory, wherein the filter rule setting portion determines the type of packets to be discarded based on the frequency information determined for the reception packets that have been stored in the memory, and stores a second filter rule set in the discard filter table storage in place of the first filter rule set, the second filter rule set including a filter rule indicating the determined type of packets to be discarded.

According to the invention described above, the type of packets to be discarded is determined from the result of scanning of reception packets in the memory, and a second filter rule for discarding such packets is set. This makes it possible to receive packets other than the type of packets causing the overload state while suppressing the load on the processor.

Preferably, the filter rule setting portion determines the type of packets having a reception frequency exceeding a predetermined value as the type of packets to be discarded based on the frequency information.

According to the invention described above, the load on the processor can be reduced effectively by discarding packets corresponding to the type of packets having a reception frequency exceeding a predetermined value.

Preferably, the filter rule setting portion does not determine a given type of packets as the type of packets to be discarded.

According to the invention described above, setting can be made so as not to discard packets of which transmission/reception is indispensable for the packet reception control device.

Preferably, the reception control section further includes a session management portion for holding information indicating the type of packets used for a communications application that is being executed by the processor, wherein the filter rule setting portion does not determine the type of packets indicated by the information held by the session management portion as the type of packets to be discarded.

According to the invention described above, the type of packets being used for communications by a communications application can be excluded from the types of packets to be discarded.

Preferably, when the communications application terminates communications, the session management portion outputs the information indicating the type of packets that were used for the communications application, and the filter rule setting portion determines the type of packets that were used for the communications application as the type of packets to be discarded.

According to the invention described above, when communications by a communications application is terminated and packets of which reception is no more necessary are received, the received packets can be discarded.

Preferably, the filter rule setting portion changes the second filter rule set so that more types of packets be discarded if receiving the detection result indicating that the processor is in an overload state again within a predetermined time.

According to the invention described above, when the processor becomes overloaded again after the second filter rule is stored, more types of packets than in the previous case are discarded. Therefore, the load on the processor can be reduced.

Preferably, the filter rule setting portion determines the type of packets to be discarded based on the previously-used frequency information if receiving the detection result indicating that the processor is in an overload state again within a predetermined time.

According to the invention described above, when the processor becomes overloaded again after the second filter rule is stored, re-scanning of the reception packets in the memory can be omitted.

Preferably, the reception control section further includes a learning result storage for storing a threshold, When determining the type of packets to be discarded based on the frequency information, the filter rule setting portion prepares the second filter rule set using the threshold stored in the learning result storage, and the learning result storage changes the stored threshold according to the intervals of reception of the detection result indicating that the processor is in an overload state.

According to the invention described above, the type of packets to be discarded can be determined appropriately according to the use style.

Preferably, the filter rule setting portion selects a predetermined number of types among the types of reception packets in descending order of the reception frequency based on the frequency information, and determines the selected types as the types of packets to be discarded.

According to the invention described above, the load on the processor can be effectively reduced by discarding packets in the manner of putting a higher priority for discarding on the type of packets larger in reception frequency.

Preferably, the reception control section further includes a queue management portion for holding the number of reception packets allowed to be stored in the memory, and the filter rule setting portion increases the number of reception packets allowed to be stored in the memory, held by the queue management portion, if receiving the detection result indicating that the processor is in an overload state.

According to the invention described above, since the number of reception packets stored in the memory increases, the accuracy of determination of the type of reception packets to be discarded improves.

Preferably, the reception packet transfer section stores at least header information of reception packets in the memory, and the packet analysis section scans the header information stored in the memory to determine the frequency information.

According to the invention described above, the type of packets to be discarded can be determined based on header information of packets received in the past.

Preferably, the filter rule setting portion sets the first filter rule set so that all packets be discarded.

Preferably, the packet is an Ethernet MAC frame.

The semiconductor integrated circuit of the present invention includes: the packet reception control device described above; and a processor for receiving packets according to the results of determination by the packet reception control device.

The packet reception control method of the present invention is a packet reception control method for storing reception packets in a memory and then outputting the packets to a processor. The method includes the steps of: detecting whether or not the processor is in an overload state; storing a first filter rule set including a filter rule indicating that a predetermined type of packets should be discarded if receiving the detection result indicating that the processor is in an overload state; discarding a reception packet matching any of the filter rules and outputting a reception packet matching none of the filter rules to the processor via the memory; scanning information on reception packets that have been stored in the memory according to the first filter rule set, to obtain frequency information indicating the reception frequency for each type of the reception packets; determining the type of packets to be discarded based on the frequency information; and storing a second filter rule set including a filter rule indicating the determined type of packets to be discarded in place of the first filter rule set.

Preferably, the step of determining the type of packets to be discarded determines the type of packets having a reception frequency exceeding a predetermined value as the type of packets to be discarded based on the frequency information.

Preferably, the step of determining the type of packets to be discarded changes a threshold used for the determination according to the intervals of reception of the detection result indicating that the processor is in an overload state

Preferably, the packet reception control method described above further includes the step of increasing the number of reception packets allowed to be stored in the memory if receiving the detection result indicating that the processor is in an overload state, wherein the step of scanning information on reception packets scans the reception packets stored in the memory to obtain the frequency information.

Preferably, the step of scanning information on reception packets scans header information of the reception packets that have been stored in the memory to obtain the frequency information.

As described above, according to the present invention, an overload state of an apparatus receiving packets can be improved. Therefore, even when a large number of packets come in a short time period, the apparatus can perform processing other than packet reception in real time.

### BRIEF DESCRIPTION OF THE DRAWINGS

FIG. 1 is a block diagram of a packet communications system in Embodiment 1 of the present invention.

FIG. 2 is a block diagram of a packet reception control device in FIG. 1.

FIG. 3 is an illustration of a format of a packet received by the packet communications system of FIG. 1.

FIG. 4 is a view showing an example of a statistic table.

FIG. 5 is a view showing an example of a discard filter table.

FIG. 6 is a block diagram of a packet reception control device of Embodiment 2 of the present invention.

FIG. 7 is a block diagram of a packet reception control device of Embodiment 3 of the present invention.

FIG. 8 is view showing an example of schedule priorities for a plurality of tasks.

FIG. 9 is a block diagram of a packet reception control device of Embodiment 4 of the present invention.

FIG. 10 is a block diagram of a packet reception control device of Embodiment 5 of the present invention.

FIG. 11 is a block diagram of a packet reception control device of Embodiment 6 of the present invention.

FIG. 12 is a flowchart showing an example of flow of operation of the packet reception control device of FIG. 11.

FIG. 13 is a view showing an example of a discard filter table including a first filter rule set.

FIG. 14 is a view showing an example of a session management table.

FIG. 15 is a view showing an example of the discard filter table including a second filter rule set.

FIG. 16 is a flowchart showing another example of flow of operation of the packet reception control device of FIG. 11.

FIG. 17 is a block diagram of a packet reception control device of Embodiment 7 of the present invention.

FIG. 18 is a flowchart showing part of a flow of operation of the packet reception control device of FIG. 17.

FIG. 19 is a flowchart showing a continuation of the flow of operation shown in FIG. 18.

FIG. 20 is a block diagram of a packet reception control device of Embodiment 8 of the present invention.

FIG. 21 is a flowchart showing a flow of operation of the packet reception control device of FIG. 20.

FIG. 22 is a block diagram of a packet reception control device of Embodiment 9 of the present invention.

FIG. 23 is a block diagram of a conventional system for network incorporation.

### DESCRIPTION OF THE PREFERRED EMBODIMENTS

Hereinafter, preferred embodiments of the present invention will be described with reference to the accompanying drawings.

### Embodiment 1

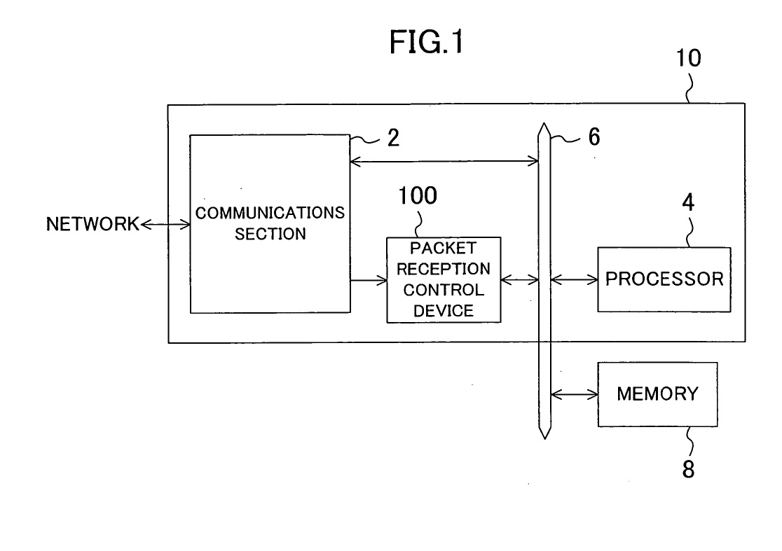

FIG. 1 is a block diagram of a packet communications system in Embodiment 1 of the present invention. The packet communications system of FIG. 1 includes a memory 8 and a semiconductor integrated circuit 10. The semiconductor integrated circuit 10 includes a communications section 2, a processor 4 and a packet reception control device 100. The processor 4 may be a CPU or a digital signal processor (DSP), for example.

The communications section 2 transmits/receives packets to/from a network, and outputs received packets (reception packets) to the packet reception control device 100. The communications section 2 also transfers/receives packets and the like to/from the processor 4 and the memory 8 via a bus 6 as required.

The packet reception control device 100 outputs packets received from the communications section 2 to the memory 8 via the bus 6. The processor 4 reads packets from the memory 8. The packet reception control device 100 controls such transfer of packets from the communications section 2 to the processor 4 according to the state of the processor 4.

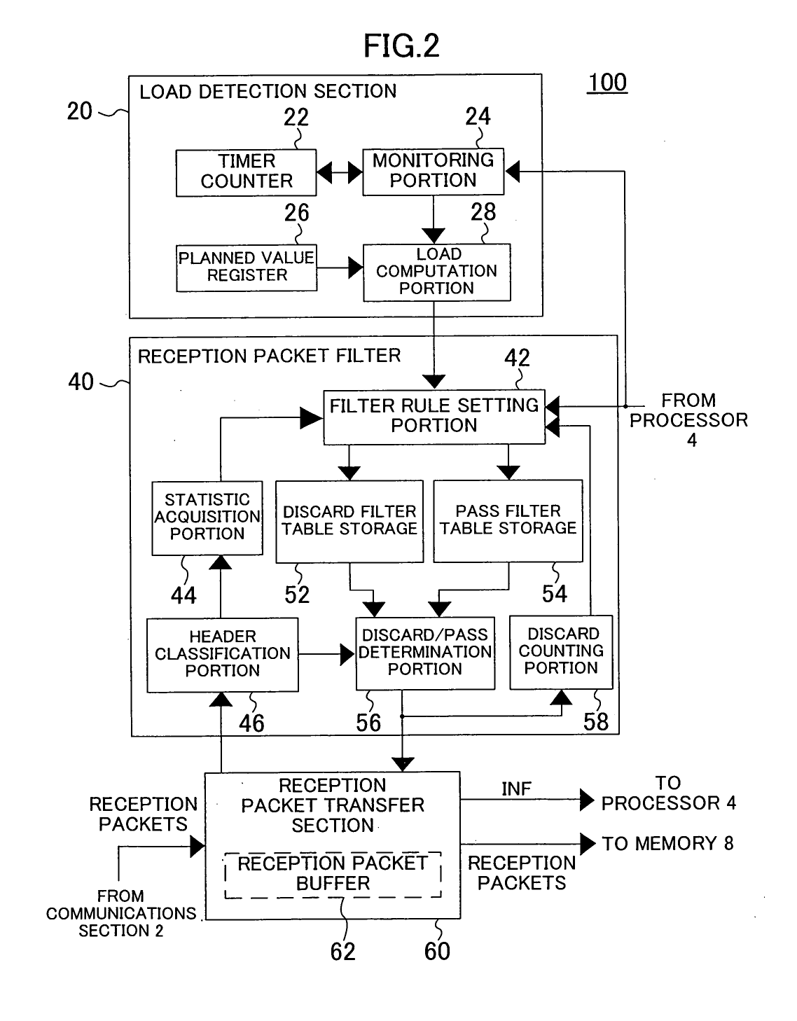

FIG. 2 is a block diagram of the packet reception control device 100 in FIG. 1. The packet reception control device 100 of FIG. 2 includes a load detection section 20, a reception packet filter 40 as the reception control section, and a reception packet transfer section 60.

The load detection section 20 includes a timer counter 22, a monitoring portion 24, a planned value register 26 and a load computation portion 28. The reception packet filter 40 includes a filter rule setting portion 42, a statistic acquisition portion 44, a header classification portion 46, a discard filter table storage 52, a pass filter table storage 54, a discard/pass determination portion 56 and a discard counting portion 58. The reception packet transfer section 60 includes a reception packet buffer 62.

The processor 4 executes a task of accessing the monitoring portion 24, which is started periodically on a multitask OS. The processor 4 sets in advance a value representing the period of this task started periodically, expressed in units of time intervals of the counting up of the timer counter 22, in the planned value register 26 as the planned value.

The timer counter 22 is a counter incrementing according to a clock and is cleared to 0 at startup. The timer counter 22 stops counting when the count value reaches a value twice as large as the value of the planned value register 26.

When receiving access from the processor 4, the monitoring portion 24 reads the count value of the timer counter 22, outputs the read value to the load computation portion 28, and then restarts the timer counter 22. The load computation portion 28 detects a processing load based on the input count value and the planned value read from the planned value register 26, and outputs the detected processing load, which is a value corresponding to the degree of the load on the processor 4, to the filter rule setting portion 42.

To state specifically, the load computation portion 28 subtracts the planned value from the input count value and divides the subtracted value by the planned value to give the resultant value as the processing load. The processing load will be 0 if the input count value does not exceed the planned value. The processing load is a value representing the load on the processor 4, which will be 0 if the processor 4 has no processing load or has enough processing power, and will be a positive value if the processor 4 is short of processing power.

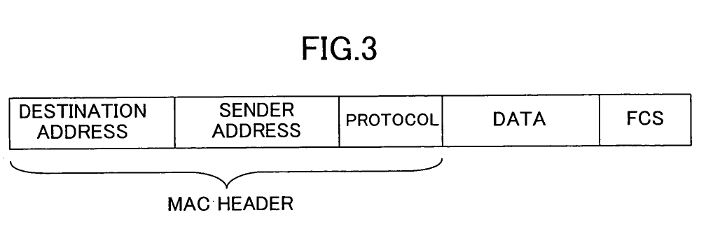

FIG. 3 is a view illustrating a format of a packet received by the packet communications system of FIG. 1. The packet of FIG. 3 is an Ethernet media access control (MAC) frame composed of a header (MAC header) and the remainder. The header includes a destination address, a sender address and a value indicating a protocol. In the following description, assume that a reception packet refers to a MAC frame.

The reception packet transfer section 60 receives a reception packet from the communications section 2, holds at least part of the packet in the reception packet buffer 62, and receives an instruction from the discard/pass determination portion 56 of the reception packet filter 40. If being instructed to pass the packet, the reception packet transfer section 60 sends a notification INF of reception of the packet to the processor 4 and outputs the packet to the memory 8. If being instructed to discard the packet, the reception packet transfer section 60 clears the reception packet buffer 62 without outputting the reception packet. The reception packet transfer section 60 also retrieves at least the header of the reception packet and sends the retrieved part to the header classification portion 46. Note that in passing the packet, the processor 4 may read the packet from the reception packet buffer 62 directly in response to the notification INF of reception of the packet.

The header classification portion 46 analyzes the received header, retrieves the destination address and the protocol value, and outputs the retrieved part to the statistic acquisition portion 44 and the discard/pass determination portion 56.

The pass filter table storage 54 stores therein a pass filter table. In the pass filter table, combinations of the destination addresses and the protocol values of packets to be passed regardless of the situation are set by the number required as filter rules by the processor 4 via the filter rule setting portion 42.

The discard filter table storage 52 stores therein a discard filter table. In the discard filter table, combinations of the destination addresses and the protocol values of packets to be discarded at the current time are set by the number required as filter rules by the filter rule setting portion 42. In general, such combinations are often set so that values within a given range fit, or are given by logically inverting values for packets of which passing is desired. In special cases, special values all destination addresses and all protocol values match, or special values a specific type of destination addresses match may be set in the discard filter table storage 52.

The discard/pass determination portion 56 first compares the received combination of the destination address and the protocol value with each combination set in the pass filter table storage 54. If determining that there is a match as a result of the comparison, the discard/pass determination portion 56 instructs the reception packet transfer section 60 to pass the packet in question.

If determining that there is no match as a result of the comparison, the discard/pass determination portion 56 compares the received combination of the destination address and the protocol value with each combination set in the discard filter table storage 52. If determining that there is no match, the discard/pass determination portion 56 instructs the reception packet transfer section 60 to pass the packet in question. If determining that there is a match, the discard/pass determination portion 56 instructs the reception packet transfer section 60 to discard the packet in question.

The discard counting portion 58 counts the number of times of instruction of discarding a packet issued by the discard/pass determination portion 56 per unit time, and outputs the resultant discard count per unit time to the filter rule setting portion 42.

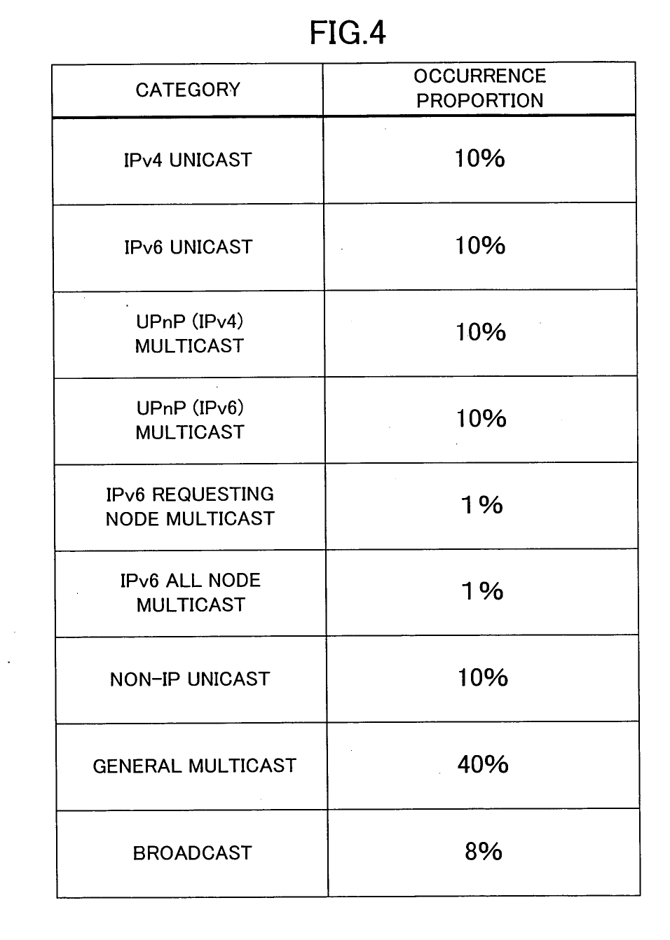

The statistic acquisition portion 44 classifies the combinations of the destination addresses and the protocol values given from the header classification portion 46 and obtains the number of occurrences per unit time and the occurrence proportion for each category in the form of a statistic table. FIG. 4 shows an example of such a statistic table.

The filter rule setting portion 42 changes the values set in the discard filter table storage 52 according to the processing load received from the load computation portion 28. Specifically, if the processing load is +50%, for example, the filter rule setting portion 42 refers to the statistic table to select categories in descending order of the occurrence proportion until the total amount exceeds the value of the processing load (50%), and sets filter rules corresponding to the selected categories in the discard filter table.

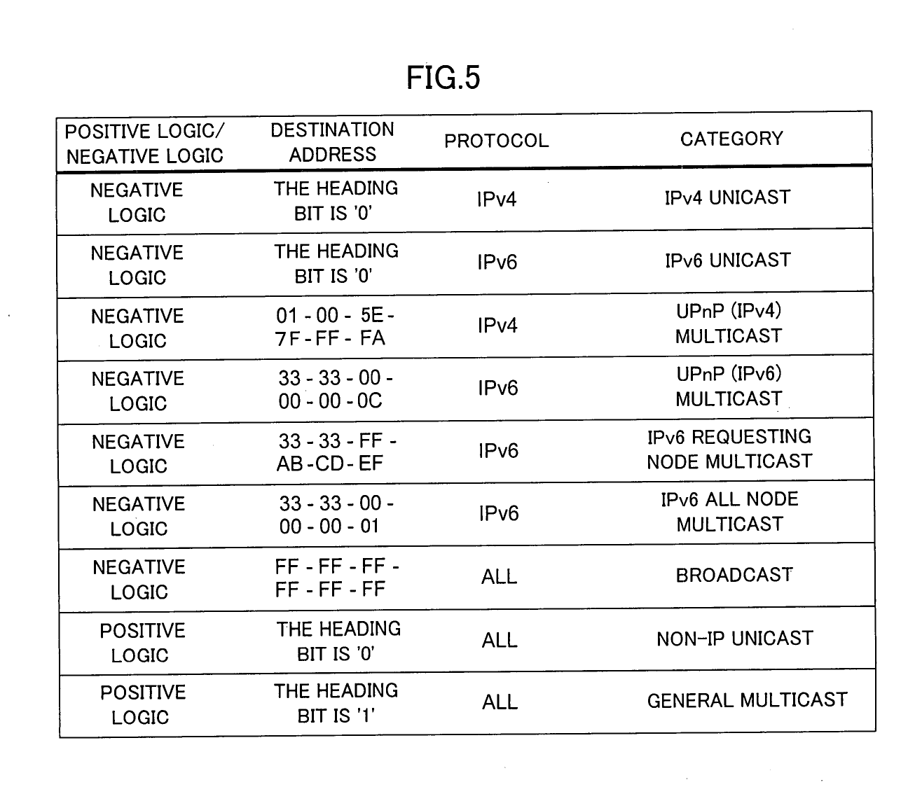

FIG. 5 is a view showing an example of the discard filter table. FIG. 5 shows the case that the filter rule setting portion 42 selected general multicast and non-IP unicast in the statistic table of FIG. 4. The discard/pass determination portion 56 regards any packet that does not satisfy any of the conditions in the rows specified as negative logic and satisfies any of the conditions in the rows specified as positive logic in the discard filter table of FIG. 5 as “matching”, and instructs the reception packet transfer section 60 to discard such a packet.

In the case that the processing load decreases from the previously measured value, the filter rule setting portion 42 refers to the discard count per unit time obtained by the discard counting portion 58. The filter rule setting portion 42 does not change the setting of the discard filter table if the discard count per unit time is equal to or more than a predetermined threshold, and updates the discard filter table if the discard count is less than the threshold. The updating of the discard filter table is made according to the processing load as already described.

As described above, in the packet reception control device 100 of FIG. 2, the contents of the discard filter table are set according to the processing load detected by the load detection section 20. Accordingly, an appropriate filter rule can be selected dynamically with a change in processing load.

A filter rule narrowed to reception packets responsible for the load can be obtained based on the statistic nature of reception packets.

Reception packets important in the operation of equipment can be excluded from the target of the filter rule even if the processing load thereof is large.

The setting of the discard filter table is changed only after reduction in processing load and reduction in the number of reception packets discarded through filtering are confirmed. Accordingly, the setting of the filter for use at overloading can be maintained as long as an overload occurs.

The processing load for a task on a multitask OS can be expressed as a numerical value simply independent of the natures of the processor and the program.

In this embodiment, the type of packets to be discarded was selected in descending order of the occurrence proportion based on the statistic table obtained by statistically measuring the types of received packets. Alternatively, any other order may be adopted in the selection. The point is that the contents of the discard filter table should be set to be adaptive to more reception packets with increase of the processing load. By this setting, the original effect of the packet reception control device can also be obtained. The degree of importance and necessity of packets may be considered in the selection. For example, the selection may be made in ascending order of importance.

A special case may be set in the discard filter table to be adopted when the processing load exceeds a predetermined value. For example, setting may be made to discard all multicast packets and broadcast packets if the processing load exceeds 80%, and to discard all reception packets if the processing load exceeds 90%. With this setting, the processor can be immediately relieved of the load of processing reception packets when the processing by the processor becomes especially heavy.

In this embodiment, the discard count from the discard counting portion 58 was referred to when the processing load decreased. Alternatively, the setting of the discard filter table may be kept unchanged for a predetermined time period after the decrease of the processing load. In this case, unduly sensitive response to a variation in the processing load of the processor can be avoided.

### Embodiment 2

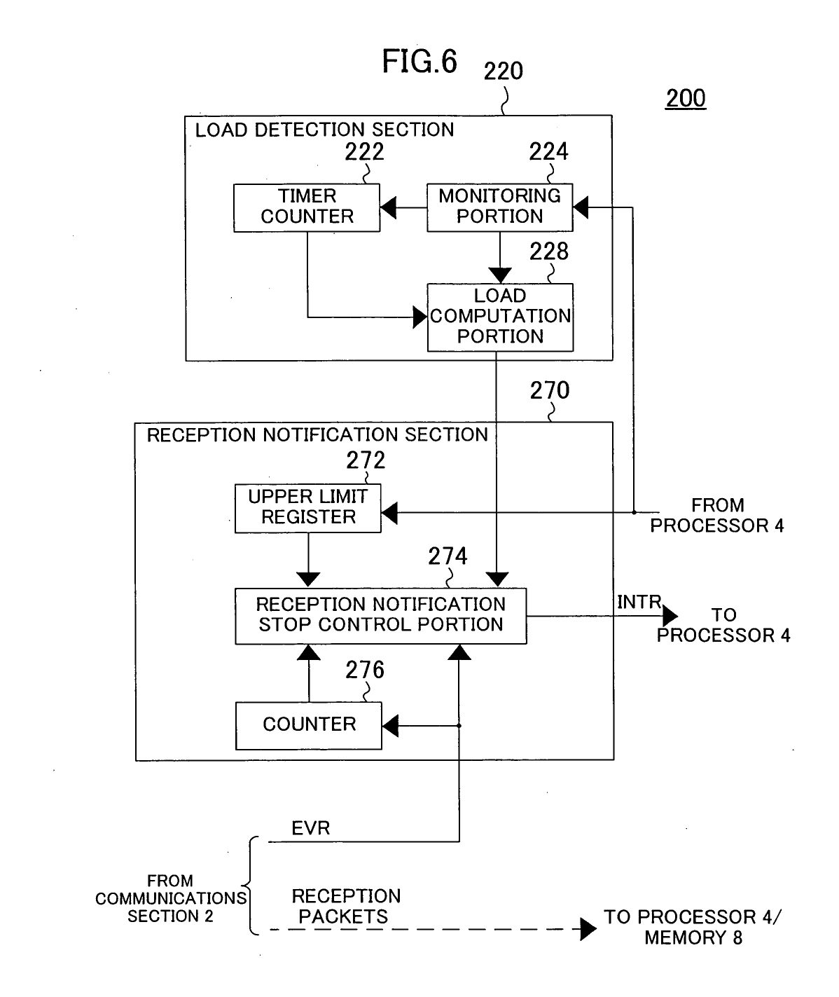

FIG. 6 is a block diagram of a packet reception control device 200 of Embodiment 2 of the present invention. The packet reception control device 200 of FIG. 6 includes a load detection section 220 and a reception notification section 270 as the reception control section. The packet reception control device 200 is used in place of the packet reception control device 100 in the packet communications system of FIG. 1.

The load detection section 220 includes a timer counter 222, a monitoring portion 224 and a load computation portion 228. The reception notification section 270 includes an upper limit register 272, a reception notification stop control portion 274 and a counter 276.

The processor 4 executes a task of accessing the monitoring portion 224. The task is started periodically on a multitask OS by the processor 4. The period of the task is set to be shorter than the timeout of the timer counter 222. The timeout is defined as the time that has elapsed from the start of counting of the timer counter 222 until the timer counter 222 outputs a timeout signal without being cleared.

The timer counter 222, counting a clock, outputs the timeout signal to the load computation portion 228 once the count value reaches a predetermined value (timeout value), and restarts counting from the initial value. The timeout value should be a value with which the timeout will be shorter than the unit time, and may be made settable from the processor 4.

The monitoring portion 224 generates a clear signal when receiving access from the processor 4 and outputs the clear signal to the timer counter 222. The timer counter 222 is cleared when receiving the clear signal and then restarts clock counting from the initial value.

The load computation portion 228 measures the number of times of generation of the timeout signal from the timer counter 222 per unit time, and outputs the measured value as the processing load. The processing load is a value representing the load on the processor 4, which will be 0 if the processor 4 has no load to be processed or has enough processing power, and will be a positive value if the processor 4 is short of processing power. The processing load is larger as the load on the processor 4 is larger. The maximum processing load is a value obtained by dividing the unit time by the timeout.

The load computation portion 228 may otherwise perform some computation for the measured value and output the computed result as the processing load.

The communications section 2 generates a reception-related event signal EVR when receiving a packet from the network, and outputs the signal EVR to the reception notification stop control portion 274 and the counter 276. The communications section 2 generates the event signal EVR, not only when receiving a packet normally, but also when receiving a wrong packet or having an overflow therein. The event signal EVR may also include notification of a cause of an event.

The counter 276 counts the number of times of generation of the reception-related event signal EVR per unit time, and outputs the count value, representing the frequency of generation of the event signal EVR, to the reception notification stop control portion 274.

When receiving the reception-related event signal EVR, the reception notification stop control portion 274 basically notifies the processor 4 of this reception with a reception-related notification signal INTR as long as the processor 4 is not stopped. The reception-related notification signal INTR is an interrupt signal for the processor 4. The reception notification stop control portion 274 may record the cause of the notification, if necessary, to enable confirmation by the processor 4. When receiving the notification, the processor 4 starts an interrupt handling program, in which the cause of the notification is analyzed and data of the reception packet from the communications section 2 is transferred to the memory 8 if necessary.

The upper limit register 272 has an upper limit value set from the processor 4. The reception notification stop control portion 274 compares the processing load received from the load detection section 220 with the upper limit value set in the upper limit register 272, and stops the notification to the processor 4 with the reception-related notification signal INTR if the processing load exceeds the upper limit value.

When detecting that the processing load received from the load detection section 220 has changed its state from being larger to being smaller than the upper limit value, the reception notification stop control portion 274 cancels the stop of the notification to the processor 4 with the reception-related notification signal INTR if the count value of the counter 276 is equal to or less than a predetermined threshold, and maintains the stop of the notification if the count value exceeds the threshold.

As described above, the packet reception control device 200 of FIG. 6 prohibits occurrence of an interrupt caused by a notification related to a reception packet if the processing load exceeds the upper limit value. In this way, the power of the processor can be kept from undue interrupt handling and reception processing. In particular, the power of the processor can be kept from a load caused by a notification related to a reception error from the communications section 2.

The setting of stopping the notification with the interrupt signal can be maintained as long as an overload occurs, and thereafter, once reduction in the frequency of generation of the event signal EVR is confirmed, the normal state can be restored automatically.

Since the processing load is computed from the frequency of occurrence of timeout per unit time, stable determination can be made by using the processing load averaged in the unit time.

The reception notification stop control portion 274 in this embodiment cancels the setting of stopping the notification to the processor 4 only after confirming that the frequency of generation of the event signal EVR is equal to or less than a predetermined threshold. Alternatively, the setting may be canceled a predetermined time after start of the stop of the notification. In this case, it is possible to restore the normal state automatically while avoiding unduly sensitive response of the packet reception control device.

The load computation portion 228 in this embodiment measures the number of times of timeout per unit time. Alternatively, the maximum of the number of times of consecutive generation of the timeout signal in the unit time may be measured. In this case, the momentary maximum processing load in the latest unit time can be measured, and thus an overload or not can be determined for the portion of the unit time in which the load is largest.

The timeout value of the timer counter 222 in this embodiment is invariably fixed. Alternatively, the timeout value may be changed every time a timeout occurs or every time the counter is cleared. By increasing the timeout value every time a timeout occurs or by reducing the timeout value every time the counter is cleared, the load computation portion 228 can use the number of times of consecutive generation of the timeout signal as a value swiftly following a variation in processing load.

In the above description, the reception notification section 270 generates the reception-related notification signal INTR to the processor 4. Alternatively, the communications section 2 may generate the reception-related notification signal INTR, and the reception notification section 270 may instruct the communications section 2 to stop the generation of the reception-related notification signal INTR.

The load detection section 20 in FIG. 2 may be used in place of the load detection section 220 in FIG. 6. Likewise, in Embodiment 1, the load detection section 220 may be used in place of the load detection section 20.

### Embodiment 3

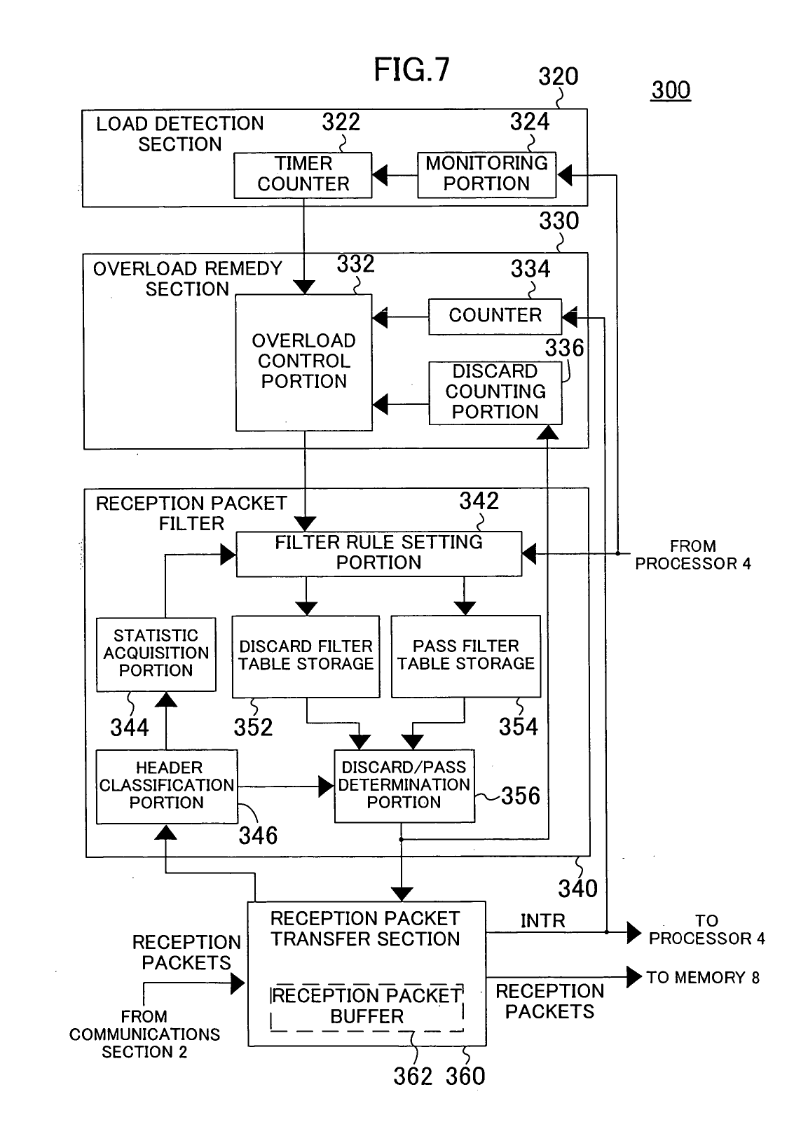

FIG. 7 is a block diagram of a packet reception control device 300 of Embodiment 3 of the present invention. The packet reception control device 300 of FIG. 7 includes a load detection section 320, an overload remedy section 330, a reception packet filter 340 as the reception control section, and a reception packet transfer section 360. The packet reception control device 300 is used in place of the packet reception control device 100 in the packet communications system of FIG. 1.

The load detection section 320 includes a timer counter 322 and a monitoring portion 324. The overload remedy section 330 includes an overload control portion 332, a counter 334 and a discard counting portion 336. The reception packet filter 340 includes a filter rule setting portion 342, a statistic acquisition portion 344, a header classification portion 346, a discard filter table storage 352, a pass filter table storage 354 and a discard/pass determination portion 356.

The reception packet transfer section 360, which includes a reception packet buffer 362, is roughly the same as the reception packet transfer section 60 in FIG. 2 except for the following point. That is, the reception packet transfer section 360 notifies the processor 4 of occurrence of a reception-related event with a reception-related notification signal INTR that is an interrupt signal for the processor 4. Simultaneously, the reception packet transfer section 360 holds therein the type of the event to allow the processor 4 to access this information.

The monitoring portion 324 generates a clear signal when receiving access from the processor 4 and outputs the clear signal to the timer counter 322. The timer counter 322, counting a clock, is cleared when receiving the clear signal and restarts clock counting from the initial value.

The timer counter 322 outputs a timeout signal to the overload control portion 332 as an overload notification and stops counting once the count value reaches a predetermined value. The predetermined value may be made settable from the processor 4 or may be a fixed value.

The processor 4 executes a task of accessing the monitoring portion 324. The task is started periodically on a multitask OS by the processor 4. The period of startup of the task is set to be shorter than the timeout of the timer counter 322. By adjusting the ratio of the period of the task to the timeout, it is possible to change the sharpness of detection of a variation in task startup intervals and thus change the sensitivity of detection of an overload.

The statistic acquisition portion 344, the header classification portion 346 and the discard/pass determination portion 356 are roughly the same as the statistic acquisition portion 44, the header classification portion 46 and the discard/pass determination portion 56, and thus the description thereof is omitted here.

The discard filter table storage 352 stores therein a discard filter table, and the pass filter table storage 354 stores therein a pass filter table.

The filter rule setting portion 342 sets the contents of the pass filter table in the pass filter table storage 354 and the discard filter table in the discard filter table storage 352 according to instructions from the processor 4 and the overload control portion 332. The filter rule set in this occasion is a filter rule for use in normal times.

The counter 334 counts the frequency of generation of the reception-related notification signal INTR per unit time and outputs the resultant count value to the overload control portion 332.

The overload control portion 332 refers to the count value output from the counter 334 when receiving overload notification from the load detection section 320. If the count value is equal to or more than a predetermined threshold, the overload control portion 332 regards the notified overload as having occurred in relation to an interrupt caused by packet reception, and sets a filter rule for use at overloading in the discard filter table. In other words, the overload control portion 332 sets special values all reception packets match in the discard filter table via the filter rule setting portion 342.

The discard counting portion 336 counts the number of times of issuance of the instruction of discarding packets by the discard/pass determination portion 356 per unit time, and outputs the resultant discard count to the overload control portion 332. As long as the discard count is equal to or more than a predetermined threshold, the overload control portion 332 considers that the processor 4 is still in an overload state and maintains the set contents of the discard filter table. If the contents of the discard filter table have been changed, the overload control portion 332 uses the value counted by the discard counting portion 336 after the change.

If the discard count from the discard counting portion 336 is less than the predetermined threshold, the overload control portion 332 restores the original set values (the filter rule for use in normal times) as the contents of the discard filter table. The original set values may be held in the overload control portion 332 or in the reception packet filter 340.

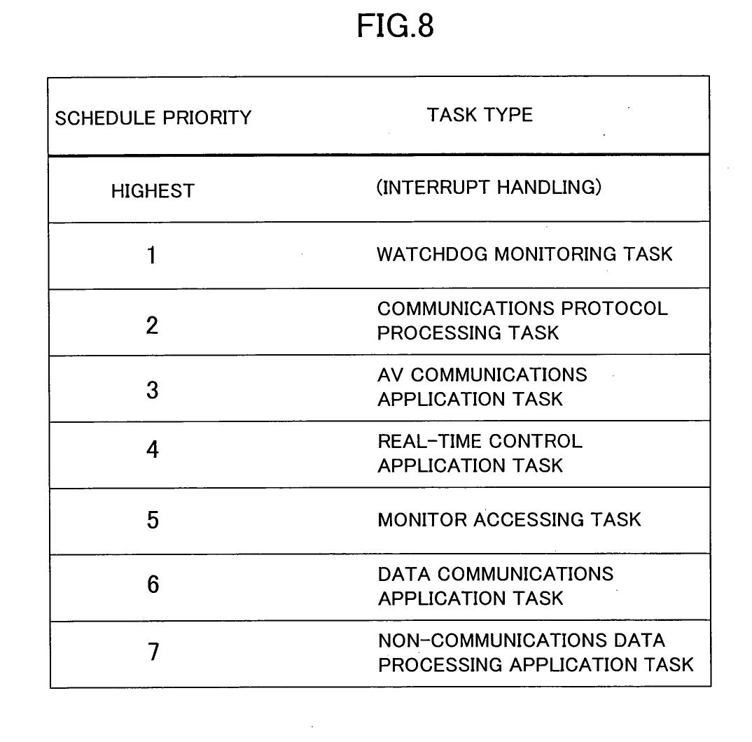

FIG. 8 is a view showing an example of schedule priorities for a plurality of tasks. Various software programs are operating as tasks in the processor 4 by use of a multitask OS. The schedule priorities are given to the tasks and the multitask OS starts tasks ready for startup in descending order of the schedule priority. In FIG. 8, a smaller value is allocated to a task higher in priority.

The task of accessing the monitoring portion 324 should be lower in schedule priority than tasks that are objects to be measured for the processing load, but should be higher in schedule priority than tasks that are not objects to be measured for the processing load.

Data communications application tasks and non-communications data processing application tasks in FIG. 8 are tasks requiring no real-time operation. In FIG. 8, these tasks are lower in priority than the task of accessing the monitoring portion 324, and are not regarded as objects to be measured for the processing load. Thus, by sacrificing processing of tasks requiring no real-time operation, it is possible to perform processing of the other tasks. In this case, the packet reception control device 300 will not determine that the processor is in an overload state even if the processing power of the processor is used to the maximum extent as a whole.

As described above, the packet reception control device of this embodiment can detect occurrence of an overload on the processor caused by packet reception in a simple way and swiftly switch the filter rule information to a filter rule for use at overloading. At the time of an overload, all reception packets can be discarded to directly minimize the processing load. Reception packets important in operation of the equipment can be excluded from the list of objects to be filtered even if they cause a large processing load.

The filter setting for use at overloading is canceled only after it is confirmed that the packet discard amount with the filter is less than a predetermined threshold. Therefore, the filter setting for use at overloading can be maintained as long as an overload occurs.

The ratio of the timeout to the period of startup of the monitoring task can be changed by changing the timeout value and the period of startup of the monitoring task, to adjust the sensitivity of detection of an overload state.

The load detection section can detect an overload state of the processor by narrowing the target to packet reception tasks and real-time application tasks among all tasks on the multitask OS.

In this embodiment, the filter rule all packets match is set in the discard filter table at the time of an overload. Alternatively, reception packets may be categorized, and a filter rule only packets large in reception frequency match may be set.

In this embodiment, the overload control portion 332 restores the original setting of the discard filter table only after confirming that the packet discard count per unit time has decreased. Alternatively, the original setting of the discard filter table may be restored after a lapse of a fixed time.

### Embodiment 4

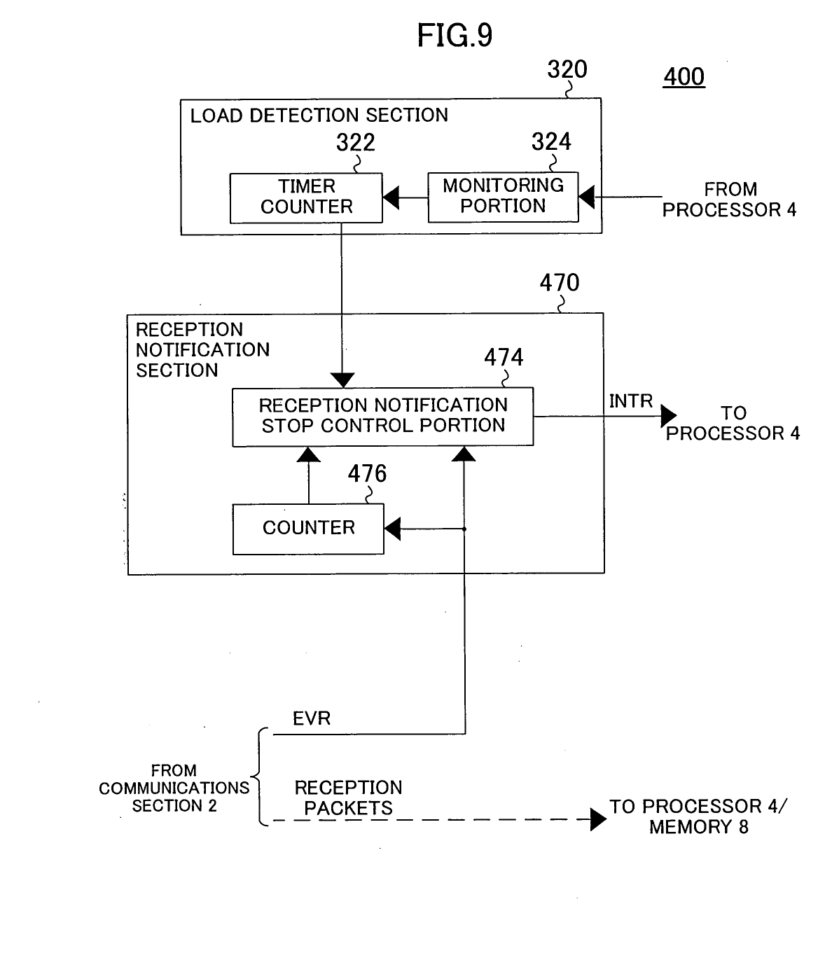

FIG. 9 is a block diagram of a packet reception control device 400 of Embodiment 4 of the present invention. The packet reception control device 400 of FIG. 9 includes a load detection section 320 and a reception notification section 470 as the reception control section. The packet reception control device 400 is used in place of the packet reception control device 100 in the packet communications system of FIG. 1. The reception notification section 470 includes a reception notification stop control portion 474 and a counter 476. The load detection section 320 is substantially the same as that described in Embodiment 3, and thus the description thereof is omitted here.

The counter 476 counts the number of times of generation of the reception-related event signal EVR described in Embodiment 2 per unit time, and outputs the count value to the reception notification stop control portion 474.

When receiving the reception-related event signal EVR, the reception notification stop control portion 474 basically notifies the processor 4 of this reception with a reception-related notification signal INTR as long as the processor 4 is not stopped. The reception-related notification signal INTR is an interrupt signal for the processor 4. The reception notification stop control portion 474 may record the cause of the notification, if necessary, to enable confirmation by the processor 4. When receiving the notification, the processor 4 starts an interrupt handling program, in which the cause of the notification is analyzed and data of the reception packet from the communications section 2 is transferred to the memory 8 if necessary.

When receiving an overload notification from the timer counter 322, the reception notification stop control portion 474 compares the count value of the counter 476 with a predetermined upper limit value. If the count value is equal to or more than the upper limit value, the reception notification stop control portion 474 stops the notification to the processor 4 with the reception-related notification signal INTR.

Thereafter, when generation of an overload notification from the timer counter 322 is stopped, the reception notification stop control portion 474 compares the count value of the counter 476 with a predetermined lower limit value. If the count value is less than the lower limit value, the reception notification stop control portion 474 cancels the stop of the notification to the processor 4 with the reception-related notification signal INTR. If the count value is equal to or more than the lower limit value, the reception notification stop control portion 474 maintains the stop of the notification. The lower limit value used may be the same as or different from the upper limit value used in the comparison made when an overload notification is received.

As described above, the packet reception control device 400 of this embodiment detects an overload state in a simple way and prohibits occurrence of an interrupt caused by a notification related to a reception packet. In this way, the power of the processor can be kept from undue interrupt handling and reception processing. In particular, the power of the processor can be kept from a load caused by a notification related to a reception error from the communications section.

The setting of stopping the notification to the processor 4 with the reception-related notification signal INTR can be maintained in an overload state, and thereafter, once reduction in the number of notifications is confirmed, the normal state, that is, the setting of notifying the processor 4 of packet reception can be restored automatically.

The reception notification stop control portion 474 in this embodiment cancels the setting of stopping the notification only after confirming that the frequency of generation of the event signal EVR per unit time (the count value of the counter 476) is less than a predetermined threshold. Alternatively, the setting may be canceled a predetermined time after the state of stopping the notification has started. In this case, it is possible to restore the normal state automatically while avoiding unduly sensitive response of the packet reception control device.

In this embodiment, the reception notification section 470 generates the reception-related notification signal INTR for the processor 4. Alternatively, the communications section 2 may generate the reception-related notification signal INTR, and the reception notification section 470 may instruct the communications section 2 to stop generation of the reception-related notification signal INTR.

### Embodiment 5

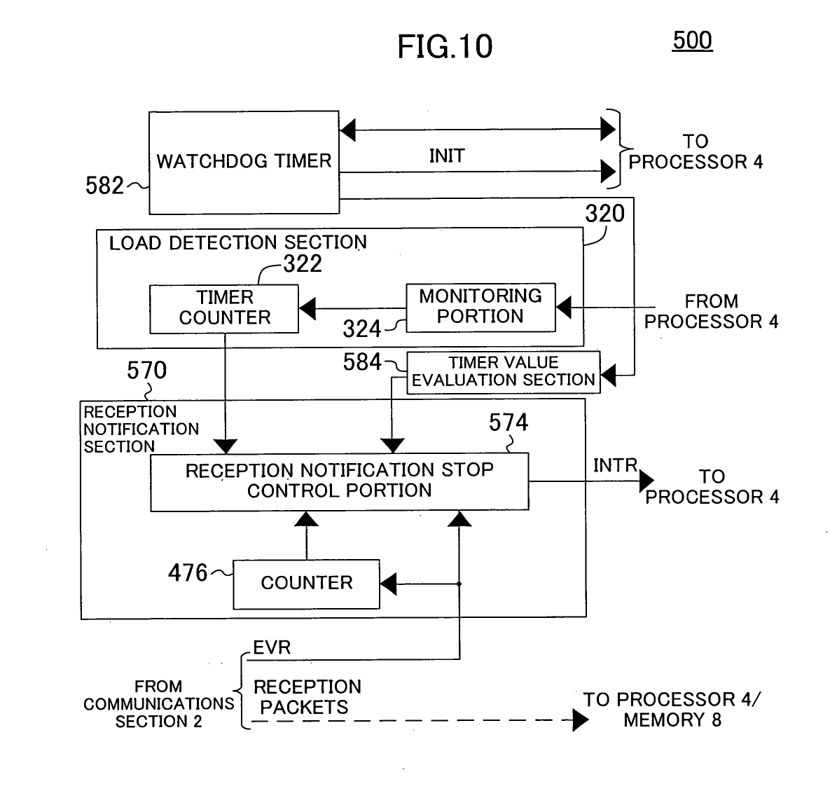

FIG. 10 is a block diagram of a packet reception control device 500 of Embodiment 5 of the present invention. The packet reception control device 500 of FIG. 10 includes a load detection section 320, a reception notification section 570 as the reception control section, a watchdog timer 582 and a timer value evaluation section 584. The packet reception control device 500 is used in place of the packet reception control device 100 in the packet communications system of FIG. 1. The reception notification section 570 includes a reception notification stop control portion 574 and a counter 476. The load detection section 320 is substantially the same as that described in Embodiment 3, and thus the description thereof is omitted here.

The watchdog timer 582 counts a clock. Once the count value reaches a predetermined value, the watchdog timer 582 generates an initialization signal INIT for the processor 4 and stops counting. The predetermined value may be made settable from the processor 4 or may be a fixed value. Once receiving the initialization signal INIT, the processor 4 initializes the processor itself and the system. If there is access from the processor 4 before the count value reaches the predetermined value, the watchdog timer 582 is cleared and restarts counting the clock from the initial value.

In the processor 4, a task of accessing the watchdog timer 582 is periodically started on a multitask OS. The period of the task is set shorter than the timeout of the watchdog timer 582. This task is that shown in FIG. 8 as the “watchdog monitoring task”. This task is higher in priority than the other tasks but is lower than interrupt handling (which is not a task to be scheduled).

The timer value evaluation section 584 reads the count value of the watchdog timer 582 and evaluates whether or not the remaining value before the timeout of the watchdog timer 582 is equal to or less than a predetermined threshold. If the remaining value is equal to or less than the threshold, the timer value evaluation section 584 instructs the reception notification stop control portion 574 to stop the notification to the processor 4 with the reception-related notification signal INTR as an interrupt signal. When receiving this instruction, the reception notification stop control portion 574 stops the notification to the processor 4 with the reception-related notification signal INTR.

The counter 476 is substantially the same as that described above with reference to FIG. 9, and the stop of the notification with the reception-related notification signal INTR can be cancelled in substantially the same manner as in Embodiment 4.

The timer value evaluation section 584 may be omitted, and the processor 4 may take on the processing done by the timer value evaluation section 584. In this case, the processor 4 starts a reception interrupt handling program when receiving the reception-related notification signal INTR from the reception notification stop control portion 574 and executes this program, to thereby perform processing equivalent to the processing done by the timer value evaluation section 584.

As described above, in the packet reception control device 500 of this embodiment, generation of the reception-related notification signal INTR related to packet reception can be stopped if the normal monitoring operation with the watchdog timer is blocked with interrupts caused by packet reception. If the interrupt signal is frequently generated, the processing power of the processor will become so tight that the processor will fail to execute even the task of clearing the watchdog timer, and as a result, the watchdog timer will generate the initialization signal. By stopping the notification signal as described above, such an occurrence can be avoided.

### Embodiment 6

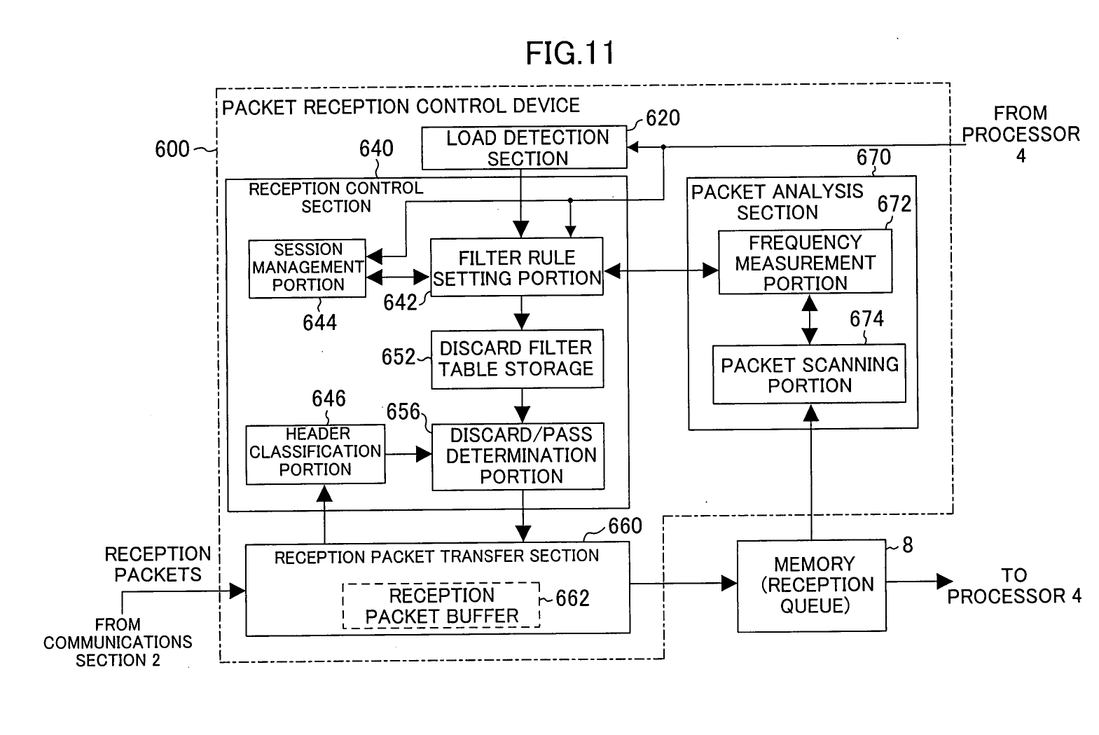

FIG. 11 is a block diagram of a packet reception control device 600 of Embodiment 6 of the present invention. The packet reception control device 600 of FIG. 11 includes a load detection section 620, a reception control section 640, a reception packet transfer section 660 and a packet analysis section 670. The packet reception control device 600 is used in place of the packet reception control device 100 in the packet communications system of FIG. 1.

The reception control section 640 includes a filter rule setting portion 642, a session management portion 644, a header classification portion 646, a discard filter table storage 652, and a discard/pass determination portion 656. The reception packet transfer section 660 includes a reception packet buffer 662. The packet analysis section 670 includes a frequency measurement portion 672 and a packet scanning portion 674.

The load detection section 620 detects a load on the processor 4 and outputs the detection result to the filter rule setting portion 642. The load detection section 620, which is only required to detect whether or not the processor 4 is in an overload state, can be substantially the same as any of the load detection sections 20, 220 and 320 described with reference to FIGS. 2, 6 and 7, respectively.

The reception packet transfer section 660 receives reception packets from the communications section 2, holds at least part of each of the packets in the reception packet buffer 662, and receives an instruction from the discard/pass determination portion 656 of the reception control section 640. If being instructed to pass the packets, the reception packet transfer section 660 outputs the reception packets to the memory 8 so that the packets be stored therein to be ready for output to the processor 4. If being instructed to discard the packets, the reception packet transfer section 660 clears the reception packet buffer 662 without outputting the packets. Also, the reception packet transfer section 660 retrieves at least the header of each reception packet and outputs the header to the header classification portion 646.

The memory 8 stores therein the received packets in the form of a reception queue. The processor 4 reads the reception packets from the reception queue in the memory 8.

The header classification portion 646 analyzes the received header, retrieves the destination address and the protocol value from the header, and outputs the retrieved information to the discard/pass determination portion 656. The discard filter table storage 652 stores therein a discard filter table as in the discard filter table storage 52 in FIG. 2.

The discard/pass determination portion 656 compares the received combination of the destination address and the protocol value with combinations set in the discard filter table storage 652. If determining that there is no combination matching the received combination in the discard filter table, the discard/pass determination portion 656 instructs the reception packet transfer section 660 to pass the packet in question. If determining that there is a match, the discard/pass determination portion 656 instructs the reception packet transfer section 660 to discard the packet in question.

The session management portion 644 holds a set of the type of packets used by one or more communications applications being executed by the processor 4 and the identifier(s) of the communications application(s) in the form of a session management table. When a communications application is terminated, the session management portion 644 deletes the type of packets used for communications by the communications application from the session management table. Also, when a communications session with the communications application is terminated, the session management portion 644 deletes the type of packets used for the communications session from the session management table. The session management portion 644 also notifies the filter rule setting portion 642 of the type of packets being used by a communications application in response to an instruction from the filter rule setting portion 642.

The filter rule setting portion 642 stores a predetermined filter rule in the discard filter table storage 652 when receiving an output of the load detection section 620 indicating that the processor 4 is in an overload state. Also, the filter rule setting portion 642 prepares a new filter rule according to the frequency information received from the frequency measurement portion 672 of the packet analysis section 670 and the type of packets being used by the communications application received from the session management portion 644, and stores the new filter rule in the discard filter table storage 652.

When receiving an instruction from the filter rule setting portion 642, the frequency measurement portion 672 instructs the packet scanning portion 674 to retrieve the sets of the destination addresses and the protocol values of the reception packets in the reception queue stored in the memory 8. When receiving the sets of the destination addresses and the protocol values of all the reception packets in the reception queue in the memory 8 from the packet scanning portion 674, the frequency measurement portion 672 classifies the received sets to obtain the reception frequency for each type of reception packets, and outputs the obtained reception frequencies to the filter rule setting portion 642 as frequency information.

When receiving the instruction from the frequency measurement portion 672, the packet scanning portion 674 scans and analyzes the headers of the reception packets in the reception queue stored in the memory 8, retrieves the destination addresses and the protocol values and outputs the retrieved information to the frequency measurement portion 672.

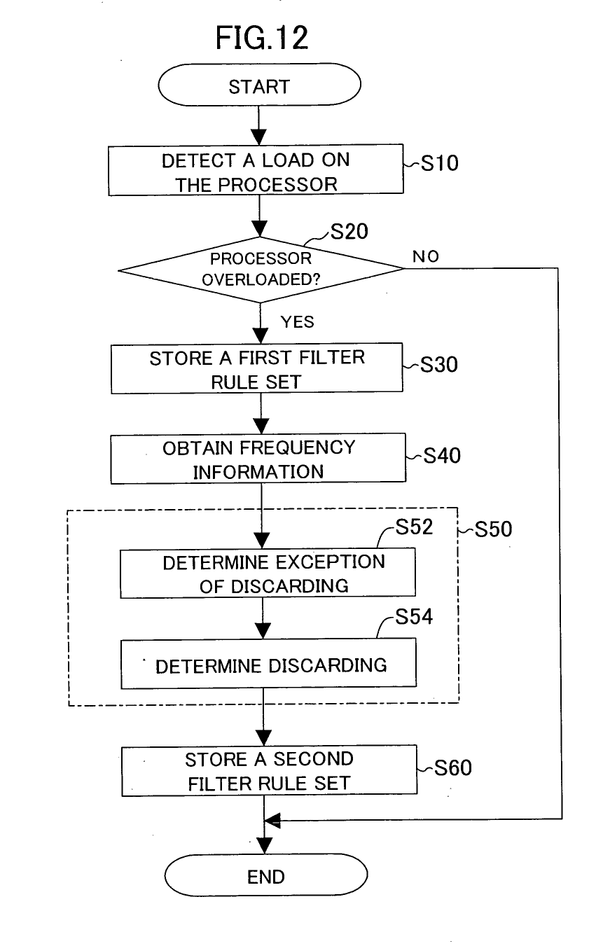

FIG. 12 is a flowchart showing a flow of operation of the packet reception control device of FIG. 11. The operation of the packet reception control device of FIG. 11 will be described with reference to FIG. 12.

In step S10, the load detection section 620 detects a load on the processor 4 and notifies the filter rule setting portion 642 of the reception control section 640 of the detection result.

In step S20, the filter rule setting portion 642 determines whether or not the processor 4 is in an overload state. If the filter rule setting portion 642 has received a notification that the processor 4 is in an overload state from the load detection section 620, the process proceeds to step S30. Otherwise, the process is terminated.

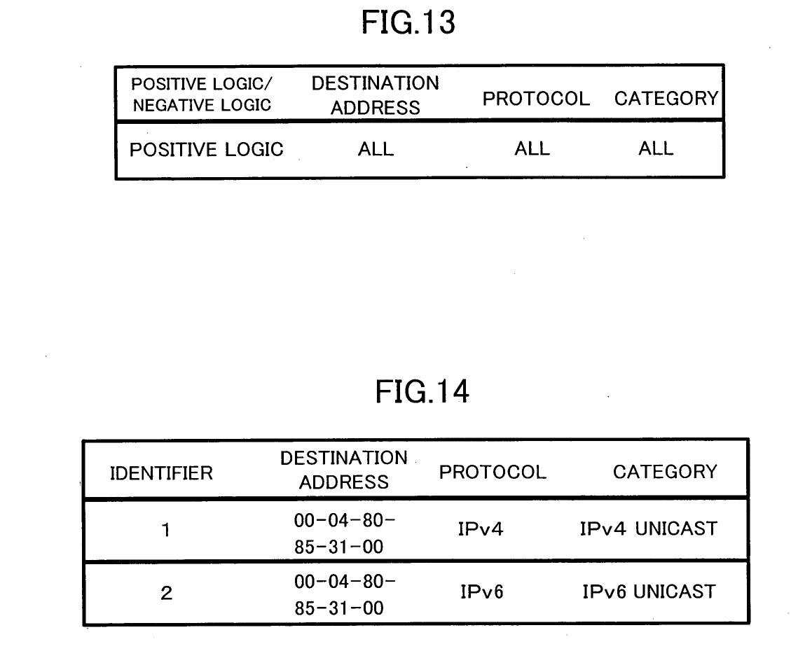

FIG. 13 is a view showing an example of the discard filter table including a first filter rule set. In the step S30, the filter rule setting portion 642 prepares the first filter rule set for use at overloading, and stores the prepared filter rule set in the discard filter table storage 652 as a first filter table. In this example, assume that a filter rule indicating that all packets should be discarded as in FIG. 13 is used.

The operation of the discard/pass determination portion 656 will be described. The discard/pass determination portion 656 regards a packet that does not satisfy any of the conditions in the rows specified as negative logic and satisfies any of the conditions in the rows specified as positive logic in the discard filter table as “matching”, and issues an instruction of discarding such a packet. In the case shown in FIG. 13, the discard/pass determination portion 656 regards all packets as “matching” and thus instructs the reception packet transfer section 660 to discard all packets.

In step S40, the filter rule setting section 642 instructs the frequency measurement portion 672 to output frequency information on the reception packets. The frequency measurement portion 672 instructs the packet scanning portion 674 to output the sets of the destination addresses and the protocol values for the reception packets. The packet scanning portion 674 scans the reception queue in the memory 8, and outputs the sets of the destination addresses and the protocol values for all the reception packets stored therein. The frequency measurement portion 672 classifies the sets output from the packet scanning portion 674 and outputs the results to the filter rule setting portion 642 as the frequency information. The frequency information obtained is like that shown in FIG. 4, for example.

Step S50, which is a step of determining packets to be discarded, is composed of step S52 of determining exception of discarding and step S54 of determining discarding.

FIG. 14 is a view showing an example of the session management table. In the step S52, the filter rule setting portion 642 instructs the session management portion 644 to output the types of packets being used by communications applications. When receiving the instruction, the session management section 644 outputs a session management table like that shown in FIG. 14, for example. The session management table of FIG. 14 indicates that the processor 4 is executing two communications applications, and that communications applications A1 (identifier 1) and A2 (identifier 2) are using IPv4 unicast packets and IPv6 unicast packets, respectively.

The filter rule setting portion 642 then excludes a predetermined type of packets, as well as the types of packets output from the session management portion 644, from the candidates of the discard filter rule. Specifically, UPnP (IPv4) multicast packets, for example, are excluded from the candidates as the predetermined type of packets. Also, the IPv4 unicast packets and the IPv6 unicast packets are excluded from the candidates of the discard filter rule based on the session management table output from the session management portion 644.

In the step S54, the filter rule setting portion 642 determines a type of packets having a reception frequency exceeding a predetermined value as the type of packets to be discarded based on the frequency information output from the frequency measurement portion 672, to prepare a discard filter rule. For example, the filter rule setting portion 642 sets the threshold at 10% and determines any type of packets having a frequency of 10% or more of the entire frequency as the type of packets to be discarded, and prepares a discard filter rule so as to discard this type of packets. As a result, the filter rule setting portion 642 determines that the packets of UPnP (IPv6) multicast, non-IP unicast and general multicast be discarded, and prepares a second filter rule set for this discarding.

In step S60, the filter rule setting portion 642 stores the thus-prepared second filter rule set in the discard filter table storage 652 in place of the first filter rule set.

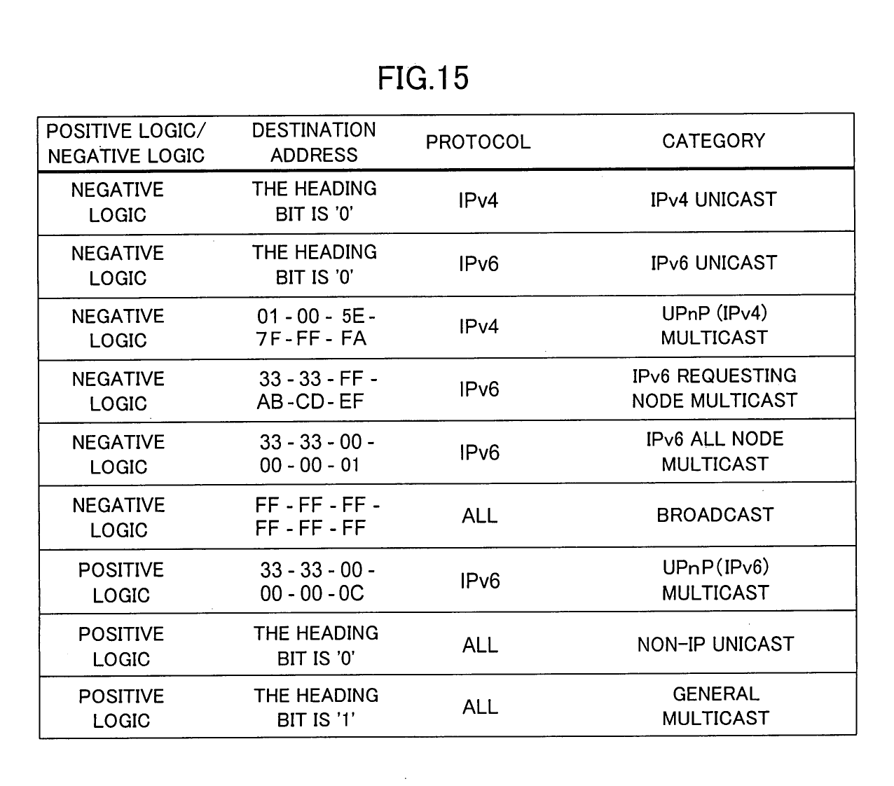

FIG. 15 is a view showing an example of the discard filter table including the second filter rule set. The discard/pass determination portion 656 regards a packet that does not satisfy any of the conditions in the rows specified as negative logic and satisfies any of the conditions in the rows specified as positive logic as “matching”, and issues an instruction of discarding such a packet.

Next, the operation carried out when a communications application terminates communications will be described. Once a communications application terminates communications, the processor 4 notifies the session management portion 644 of the termination of the communications. When receiving the notification from the processor 4, the session management portion 644 updates the session management table based on the notification and then notifies the filter rule setting portion 642 of the updating of the session management table. For example, when the communications application A2 terminates communications, the session management table of FIG. 14 is updated to have only the IPv4 unicast being used by the communications application A1.

When receiving the notification from the session management portion 644, the filter rule setting portion 642 executes the steps S52, S54 and S60 in FIG. 12 sequentially. As a result of the execution of these steps, the filter rule setting portion 642 determines the IPv6 unicast also as the type of packets to be discarded in addition to the discard filter rule prepared before the communications application A2 terminates communications, and sets a filter rule so as to discard this type of packets. As a result, a filter rule set to discard packets of IPv6 unicast, UPnP (IPv6) multicast, non-IP unicast and general multicast is stored in the discard filter table.

Thus, when a communications application terminates communications, the packet reception control device 600 sets a discard filter rule so as to discard the type of packets used for the communications.

As described above, in the packet reception control device 600 of FIG. 11, once the load detection section 620 detects an overload of the processor 4, the first filter rule set indicating that all types of packets should be discarded is first set. Reception packets stored in the reception queue are then analyzed to specify any type of packets causing the overload, and a second filter rule set indicating discarding of this type of packets is set in place of the first filter rule set. This makes it possible to continue receiving packets that are being received normally while discarding any type of packets causing the overload of the processor.

When a communications application terminates communications, the packet reception control device 600 sets a filter rule indicating that the type of packets used for the communications should be discarded. This makes it possible to discard the type of packets of which reception is no more necessary with the termination of the communications.

A type of packets having a reception frequency exceeding a predetermined value are discarded. Therefore, the load on the processor 4 can be reduced effectively.

The type of packets used by a communications application that is being executed by the processor 4 can be excluded from the candidates of the filter rule indicating packets to be discarded even if they cause a large processing load.

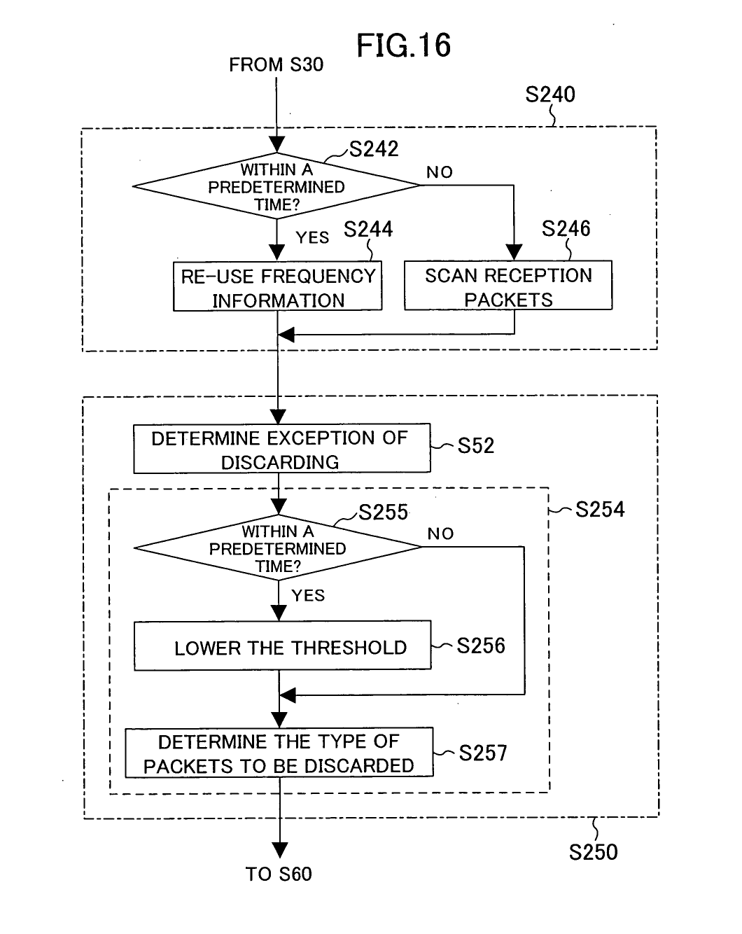

FIG. 16 is a flowchart showing another example of flow of operation of the packet reception control device of FIG. 11. Steps S240 and S250 in FIG. 16 are executed in place of the steps S40 and S50, respectively, in FIG. 11.

In step S242 in FIG. 16, when being notified that the processor 4 is in an overload state by the load detection section 620, the filter rule setting portion 642 determines whether or not a predetermined time has elapsed from the last overload notification. If the predetermined time has not elapsed, the process proceeds to step S244. Otherwise, the process proceeds to step S246.

In the step S244, the filter rule setting portion 642 does not ask for new frequency information but regards the frequency information received last time from the frequency measurement portion 672 as latest frequency information. Assuming that the frequency measurement portion 672 output the frequency information shown in FIG. 4, for example, last time, the filter rule setting portion 642 uses the frequency information shown in FIG. 4 again. The process then proceeds to the step S52.

In the step S246, the filter rule setting portion 642 instructs the frequency measurement portion 672 to send latest frequency information. Receiving the instruction from the filter rule setting portion 642, the frequency measurement portion 672 instructs the packet scanning portion 674 to output the sets of the destination addresses and the protocols of the reception packets. Receiving the instruction from the frequency measurement portion 672, the packet scanning portion 674 scans all the reception packets in the reception queue stored in the memory 8, retrieves the sets of the destination addresses and the protocols for the reception packets sequentially, and outputs the retrieved information to the frequency measurement portion 672.

The frequency measurement portion 672 classifies the sets received from the packet scanning portion 674 and stores therein the results as the frequency information. Once obtaining the frequency information for all the reception packets, the frequency measurement portion 672 outputs the resultant frequency information to the filter rule setting portion 642. When receiving the frequency information, the filter rule setting portion 642 holds the received frequency information and also sets a flag indicating that an overload on the processor 4 has been detected again within the predetermined time. The process then proceeds to the step S52.

The step S52 is the same as that described with reference to FIG. 12 and thus the description thereof is omitted here. Step S254 is executed in place of the step S54 in FIG. 12.

In step S255, the filter rule setting portion 642 determines whether or not the predetermined time has elapsed from the last overload notification. That is, whether or not a flag has been set is determined. If a flag has been set, the process proceeds to step S256. Otherwise, the process proceeds to step S257.

In the step S256, the filter rule setting portion 642 lowers the threshold of the frequency serving as the reference in the selection of the type of packets to be discarded based on the frequency information so that more types of packets can be discarded. For example, the threshold of the frequency may be lowered to 5% from 10%.

In step S257, the filter rule setting portion 642 determines any type of packets to be discarded. In other words, a filter rule is prepared so that any type of packets having a frequency exceeding a predetermined value can be discarded based on the frequency information. Assuming that the threshold was lowered to 5% in the step S256, it is determined to discard broadcast packets in addition to the packets of UPnP (IPv4) multicast, UPnP (IPv6) multicast and non-IP unicast, and a filter rule for discarding these packets is prepared.

As described above, when the processor is in an overload state again within a predetermined time, the filter rule setting portion 642 lowers the threshold of the frequency to prepare a filter rule for discarding more types of packets.

Thus, in the processing shown in FIG. 16, the filter table can be set to lighten the load on the processor 4 when the overload state of the processor 4 continues.

### Embodiment 7

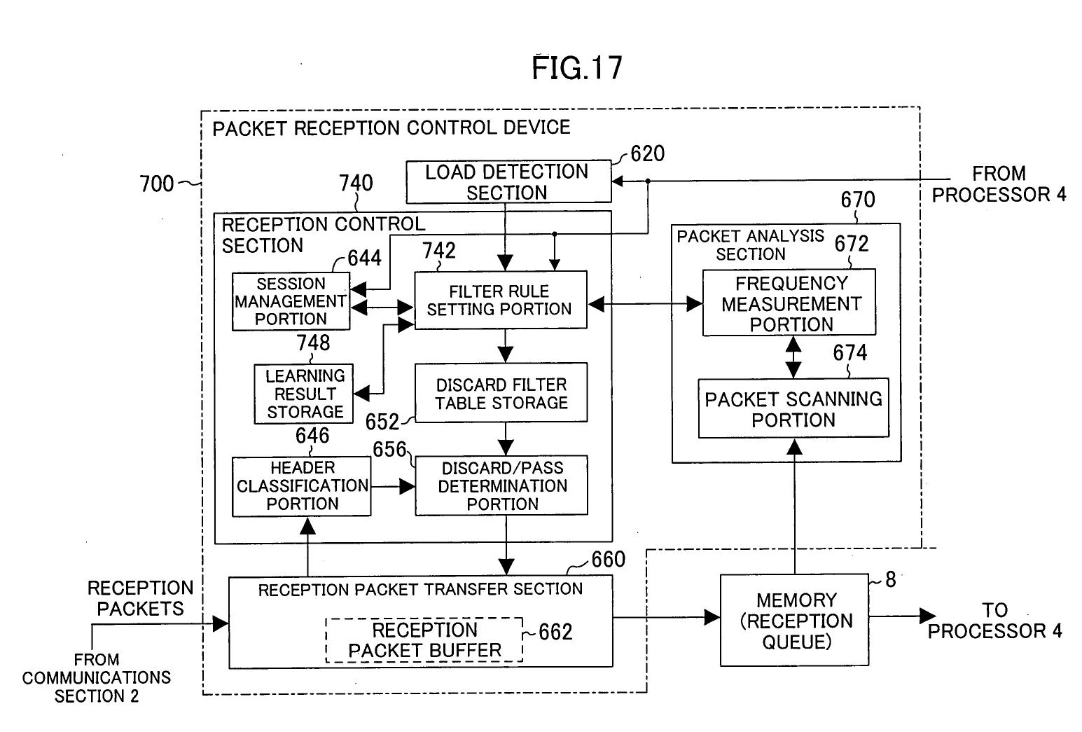

FIG. 17 is a block diagram of a packet reception control device 700 of Embodiment 7 of the present invention. The packet reception control device 700 is different from the packet reception control device 600 of FIG. 11 in that a reception control section 740 is provided in place of the reception control section 640. The reception control section 740 is different from the reception control section 640 in FIG. 11 in that a filter rule setting portion 742 is provided in place of the filter rule setting portion 642 and that a learning result storage 748 is newly provided. The other components are substantially the same as those of the packet reception control device of FIG. 11, and therefore detailed description thereof is omitted here. The packet reception control device 700 is used in place of the packet reception control device 100 in the packet communications system of FIG. 1.

The learning result storage 748 has a timer, which outputs a timer value every time receiving a notification of detection of an overload state from the filter rule setting portion 742 and then clears the timer value.

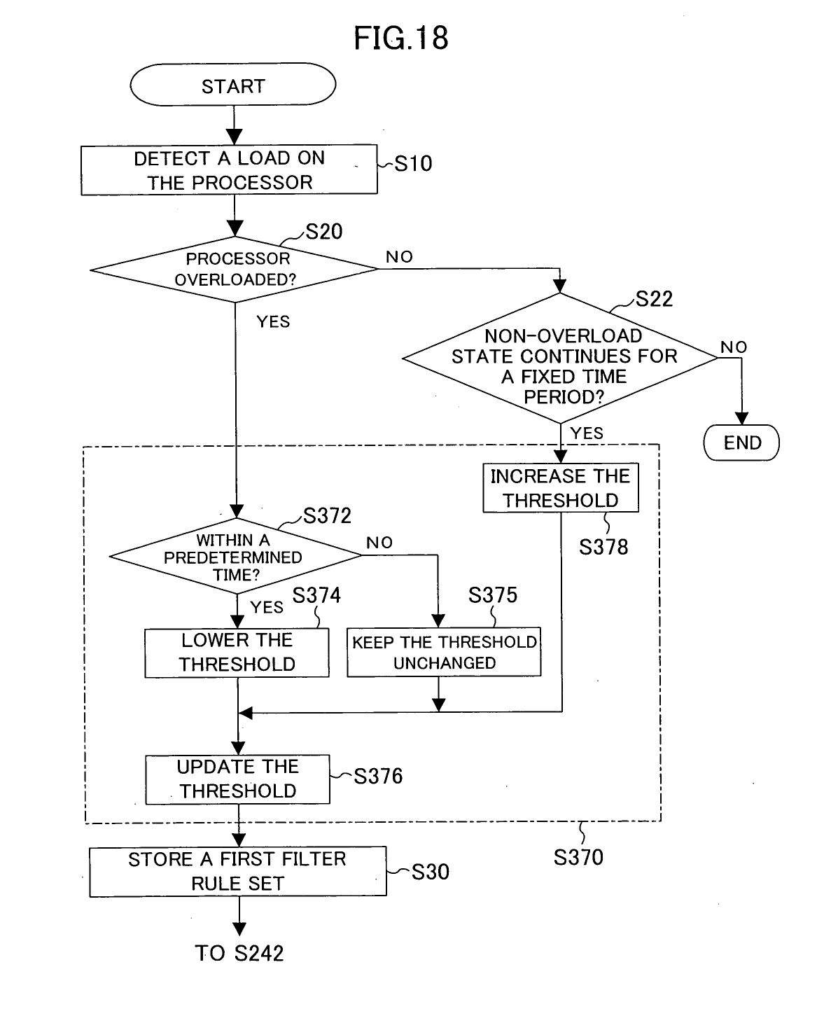

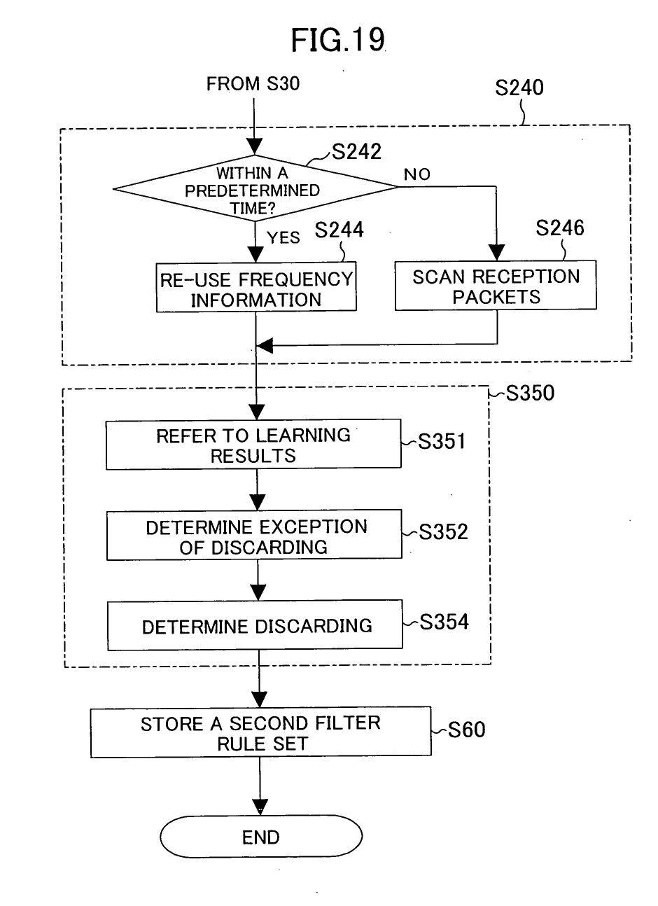

FIG. 18 is a flowchart showing part of a flow of operation of the packet reception control device of FIG. 17, and FIG. 19 is a flowchart showing a continuation of the flow of operation shown in FIG. 18. The entire flowchart of FIGS. 18 and 19 is different from the flowchart of FIG. 12 in that steps S22 and S370 are newly provided and that steps S240 and S350 are provided in place of the steps S40 and S50, respectively. The steps S10, S30 and S60 are substantially the same as those described above with reference to FIG. 12, and therefore description thereof is omitted here.

In the step S20 in FIG. 18, if the load detection section 620 notifies that the processor 4 is in an overload state, the process proceeds to step S372. Otherwise, the process proceeds to the step S22.

In the step S372, the learning result storage 748 determines whether or not the lapse of time from the last notification that the processor 4 is in an overload state is within a predetermined time. Specifically, the learning result storage 748 compares the timer value with a threshold held therein. If the timer value is smaller than the threshold, the learning result storage 748 lowers the threshold in step S374. If the timer value is equal to or larger than the threshold, the learning result storage 748 does not change the threshold in step S375. In other words, if an overload state is detected again within a predetermined time, the threshold is adjusted so that more packets can be discarded.

In step S22, the learning result storage 748 determines whether or not the non-overload state of the processor 4 continues for a fixed time period based on the notification from the filter rule setting portion 742. If the non-overload state of the processor 4 continues for a fixed time period, the process proceeds to step S378. Otherwise, the process is terminated. In the step S378, the learning result storage 748 increases the threshold. In other words, if the non-overload state continues for a fixed time period, the number of types of packets to be discarded is reduced. In step S376, the learning result storage 748 updates the threshold stored therein with the new threshold.

The step S240 in FIG. 19 is substantially the same as that described with reference to FIG. 16. Note that the fixed time period used in the determination in the step S22 must be shorter than the predetermined time used in the determination in the step S242. By setting in this way, the range of the packets to be discarded can be changed using the previously-obtained frequency information again.

In step S351, the filter rule setting portion 742 receives the threshold from the learning result storage 748. The threshold is a value obtained as a result of the learning by the learning result storage 748 based on the intervals of the detection of an overload state, as described above with reference to FIG. 18. For example, the learning result storage 748 outputs the value of 10% as the threshold.

The processing in steps S352 and S354 is roughly the same as that in the steps S52 and S54 in FIG. 12 except that the filter rule setting portion 742 uses the threshold received from the learning result storage 748, not the preset threshold, and thus description thereof is omitted here.

As described above, in the packet reception control device 700 of FIG. 17, the filter rule setting portion 742 sets the discard filter table based on the threshold updated by the learning result storage 748. Therefore, an appropriate proportion of packets can be discarded according to the degree of the load on the processor 4 and the user's use conditions.

### Embodiment 8

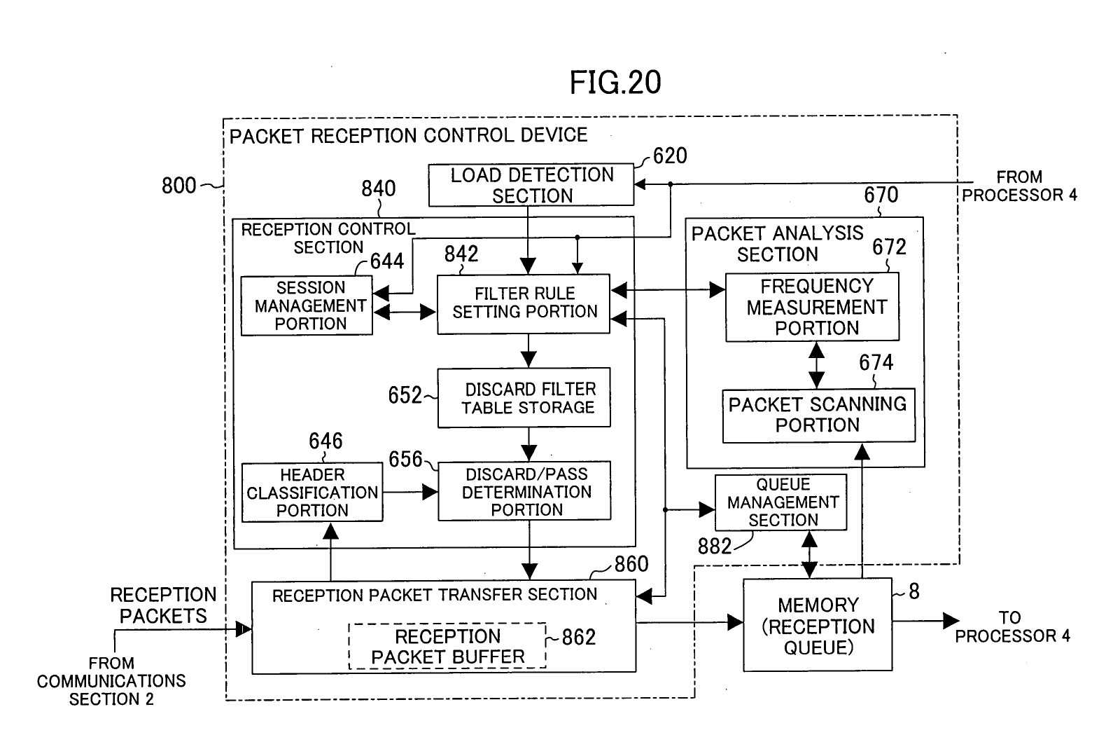

FIG. 20 is a block diagram of a packet reception control device 800 of Embodiment 8 of the present invention. The packet reception control device 800 of FIG. 20 is different from the packet reception control device 600 of FIG. 11 in that a reception control section 840 and a reception packet transfer section 860 are provided in place of the reception control section 640 and the reception packet transfer section 660 and that a queue management section 882 is newly provided. The reception control section 840 is different from the reception control section 640 in FIG. 11 in that a filter rule setting portion 842 is provided in place of the filter rule setting portion 642. The other components are substantially the same as those of the packet reception control device of FIG. 11, and therefore detailed description thereof is omitted here. The packet reception control device 800 is used in place of the packet reception control device 100 in the packet communications system of FIG. 1.

The queue management section 882 holds the number of reception packets allowed to be stored in a reception queue in the memory 8 and the number of reception packets actually stored in the memory 8 in the form of a queue management table. The reception packet transfer section 860 includes a reception packet buffer 862. The reception packet transfer section 860 updates the number of reception packets in the reception queue recorded in the queue management table when transferring a reception packet to the reception queue in the memory 8. The processor 4 also updates the number of reception packets in the reception queue recorded in the queue management table when retrieving a reception packet from the reception queue.

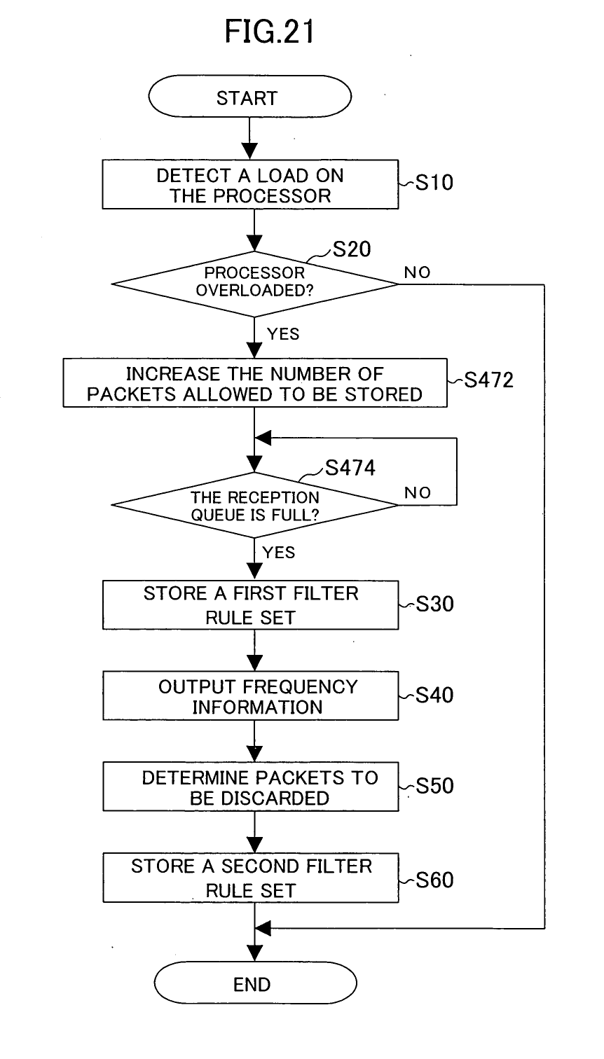

FIG. 21 is a flowchart showing a flow of operation of the packet reception control device of FIG. 20. In the flowchart of FIG. 21, steps S472 and S474 are added to the flowchart of FIG. 12. The other steps are substantially the same as those described with reference to FIG. 12, and therefore detailed description thereof is omitted here.

In the step S472, when receiving a notification that the processor 4 is in an overload state from the load detection section 620, the filter rule setting portion 842 increases the number of reception packets allowed to be stored in the reception queue in the memory 8, held by the queue management section 882.

In the step S474, the queue management section 882 refers to the queue management table to determine whether or not the reception queue is full of reception packets based on the number of reception packets allowed to be stored in the reception queue and the number of reception packets actually stored in the reception queue.

If the reception queue is full of reception packets, the queue management section 882 notifies the filter rule setting portion 842 of this fact so that a reception packet be discarded. The process then proceeds to the step S30.

If the reception queue is not full of reception packets, the queue management section 882 allows a reception packet to be stored in the reception queue in the memory 8 and updates the number of reception packets in the reception queue recorded in the queue management table. The process then returns to the processing of the step S474.

As described above, since the number of reception packets in the reception queue increases by performing the processing of the steps S472 and S474, the packet analysis section 670 can output more accurate frequency information. As a result, the filter rule setting portion 842 can determine the type of packets to be discarded more accurately.

### Embodiment 9

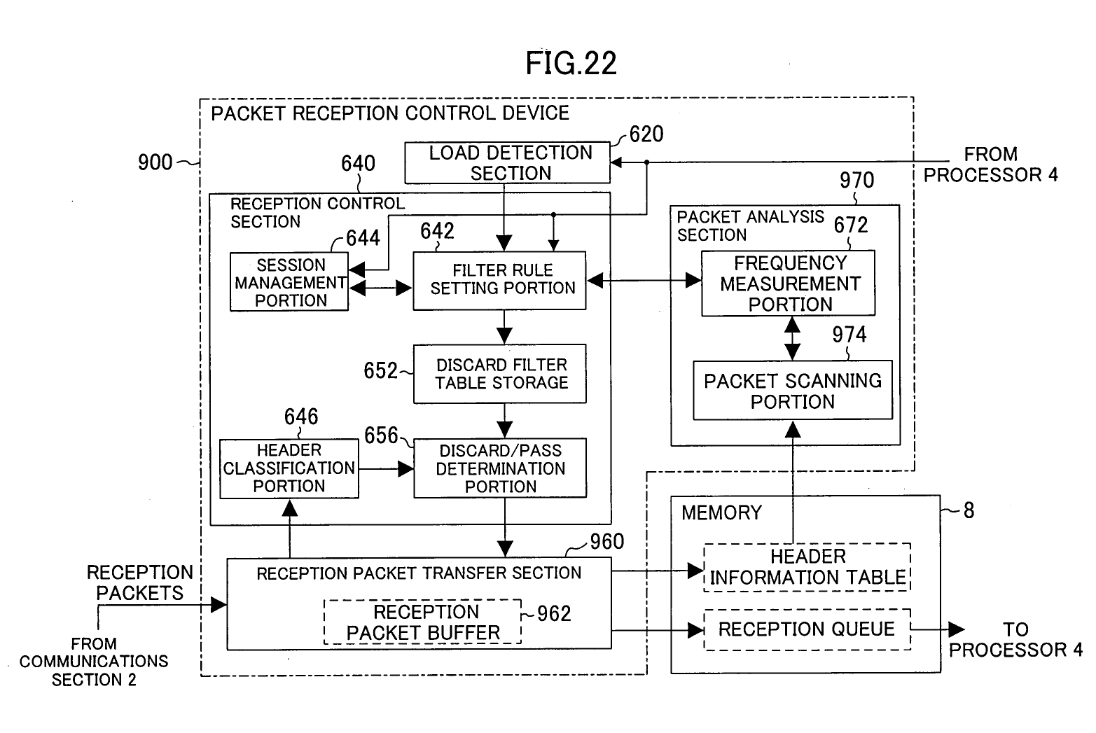

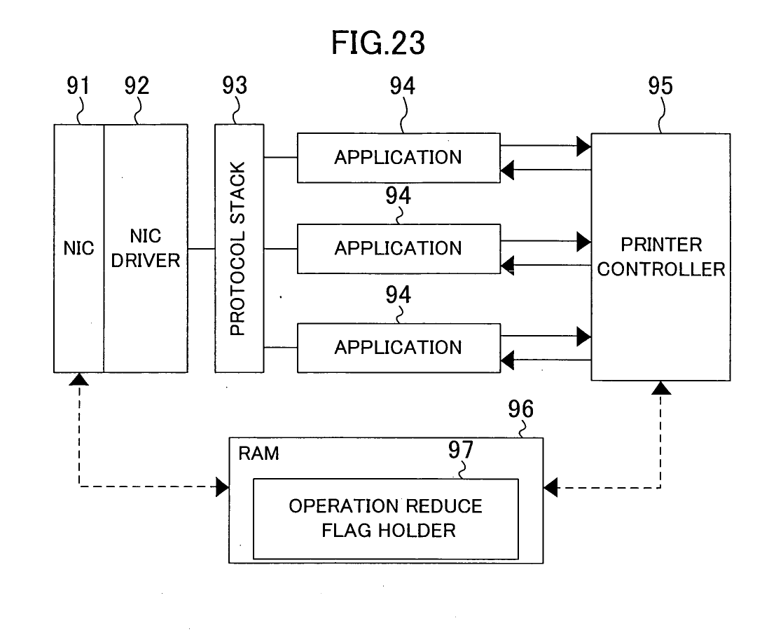

FIG. 22 is a block diagram of a packet reception control device 900 of Embodiment 9 of the present invention. The packet reception control device 900 of FIG. 22 is different from the packet reception control device 600 of FIG. 11 in that a reception packet transfer section 960 and a packet analysis section 970 are provided in place of the reception packet transfer section 660 and the packet analysis section 670. The packet analysis section 970 is different from the packet analysis section 670 in FIG. 11 in that a packet scanning portion 974 is provided in place of the packet scanning portion 674. The other components are substantially the same as those of the packet reception control device of FIG. 11, and therefore detailed description thereof is omitted here. The packet reception control device 900 is used in place of the packet reception control device 100 in the packet communications system of FIG. 1. A header information table is stored in the memory 8 in addition to the reception queue.

When receiving a reception packet from the communications section 2, the reception packet transfer section 960 transfers the reception packet to the reception queue in the memory 8 according to the instruction of the reception control section 640. The reception packet transfer section 960 also copies header information of the reception packet and stores the copied header information in the memory 8 in the form of the header information table. The header information table may have a structure of a queue, for example, in which the stored header information can be referred to from the head of the queue sequentially. The header information table includes header information of reception packets that have been stored in the memory 8 (not only reception packets currently stored in the memory 8).

When receiving an instruction from the frequency measurement portion 672, the packet scanning portion 974 scans the header information in the header information table in the memory 8 sequentially, and outputs all sets of the destination addresses and the protocols stored therein to the frequency measurement portion 672. The frequency measurement portion 672 classifies the sets output from the packet scanning portion 974, and outputs the resultant frequency information to the filter rule setting portion 642.

As described above, since the packet analysis section 970 obtains the frequency information from the header information held in the header information table, the capacity required to store information for each packet can be small. In this case, therefore, the frequency information can be obtained based on a larger number of reception packets than in the case of obtaining the frequency information from reception packets in the reception queue. Thus, the filter rule setting portion 642 can determine the type of packets to be discarded more accurately.

In the above embodiments, the packet analysis section is implemented by execution of a program by the processor 4, for example. Alternatively, the packet analysis section may be implemented by execution of a program by another processor.

The filter rule setting portion may select a predetermined number of types among the types of reception packets in descending order of the reception frequency based on the frequency information output from the frequency measurement portion 672, and determine the selected types as the types of packets to be discarded.

In the above embodiments, the reception packet filter refers to only the destination address and the protocol of the MAC frame. Alternatively, another portion of the reception packet may be referred to for the filtering. For example, IP header, TCP/UDP header and the like in a high-level layer may be referred to for the filtering, to enable selection of reception packets to be discarded in a more delicate manner.

As used herein, the unit time should be a predetermined time of a fixed length, and may be of any length.

The embodiments described above are mere examples of the present invention, and the construction of the packet reception control device of the present invention is not limited to these embodiments.

The packet reception control device of the present invention may also be used as a component of a packet filter device, a semiconductor integrated circuit and a network processor.

As described above, the packet reception control device of the present invention can detect a load on a processor and the like caused by packet reception properly and removes the load properly if an overload occurs. Accordingly, the packet reception control device of the present invention is applicable to such equipment that is connected to a network and performs real-time processing while performing communications processing.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A packet reception control device comprising:
a load detection section for detecting a load on a processor and outputting the detection result; and
a reception control section for determining whether or not the processor should receive a reception packet based on the detection result from the load detection section and outputting the determination result,
wherein the processor receives the reception packet according to the determination result from the reception control section.

2. The device of claim 1, further comprising a reception packet transfer section for receiving a packet and outputting the received packet to the processor according to an instruction,
wherein the load detection section detects a value corresponding to the degree of the load as a processing load, and
the reception control section stores therein one or more filter rules set according to the processing load, and instructs the reception packet transfer section to discard a reception packet matching any of the filter rules and output a reception packet matching none of the filter rules.

3. The device of claim 2, wherein the reception control section stores therein a rule set so that more reception packets match the rule as the processing load is larger, as the filter rule.

4. The device of claim 2, wherein the reception control section comprises a statistic acquisition portion for classifying reception packets into a plurality of types and measuring a packet reception frequency per unit time for each type, and stores therein a rule set so that reception packets of types selected in descending order of the reception frequency per unit time, among the plurality of types, match the rule, as the filter rule.

5. The device of claim 2, wherein the reception control section stores therein a rule set so that reception packets of a specific type do not match the rule, as the filter rule.

6. The device of claim 2, wherein the reception control section stores therein a rule set so that broadcast packets and multicast packets match the rule if the processing load exceeds a predetermined threshold, as the filter rule.

7. The device of claim 2, wherein the reception control section stores therein a rule set so that all packets match the rule if the processing load exceeds a predetermined threshold, as the filter rule.

8. The device of claim 2, wherein, when the processing load decreases, the reception control section does not change the filter rule for a predetermined time period after the decrease, and stores therein a rule set in correspondence with the processing load as the filter rule after a lapse of the predetermined time period.

9. The device of claim 2, further comprising a discard counting portion for measuring the frequency of discarding of reception packets by the reception control section per unit time,
wherein, when the processing load decreases, the reception control section does not change the filter rule if the frequency of discarding is equal to or more than a predetermined threshold, and stores therein information set in correspondence with the processing load as the filter rule information if the frequency of discarding becomes less than the predetermined threshold.

10. The device of claim 1, wherein the load detection section detects a value corresponding to the degree of the load as a processing load, and
when the reception control section receives an event signal generated in relation to reception of a packet, the reception control section outputs a notification signal notifying the processor of the reception of the event signal so that the processor receive the reception packet if the processing load does not exceed a predetermined value, and stops the output of the notification signal if the processing load exceeds the predetermined value.

11. The device of claim 10, wherein the notification signal is an interrupt signal for the processor.

12. The device of claim 10, wherein the reception control section measures the time elapsed from the stop of the output of the notification signal, and cancels the stop of the output of the notification signal if the measured lapse time exceeds a predetermined value.

13. The device of claim 10, wherein the reception control section measures the frequency of generation of the event signal per unit time, and cancels the stop of the output of the notification signal if the frequency of generation becomes smaller than a predetermined value after the stop of the output of the notification signal.

14. The device of claim 1, wherein the load detection section detects a value corresponding to the degree of the load as a processing load, and
the load detection section comprises:
a timer counter for measuring the time elapsed from a startup;
a monitoring portion for reading and outputting a count value of the timer counter when being accessed from the processor, and restarting the timer counter;
a load computation portion for computing the processing load based on a predetermined planned value and the read count value, and outputting the resultant processing load.

15. The device of claim 14, wherein the monitoring portion is accessed by a task started periodically on a multitask operating system (OS) by the processor.

16. The device of claim 1, wherein the load detection section detects a value corresponding to the degree of the load as a processing load, and
the load detection section comprises:
a timer counter for measuring the time elapsed from input of a clear signal and outputting a timeout signal once the measured time reaches a predetermined time;
a monitoring portion for outputting the clear signal to the timer counter when being accessed from the processor;
a load computation portion for computing the processing load based on the timeout signal.

17. The device of claim 16, wherein the load computation portion computes a value corresponding to the frequency of generation of the timeout signal per unit time as the processing load.

18. The device of claim 16, wherein the load computation portion computes a value corresponding to the number of times of consecutive output of the timeout signal as the processing load.

19. The device of claim 18, wherein a larger value is set as the predetermined time when the timer counter went to timeout, and a smaller value is set when the timer counter was cleared.

20. The device of claim 16, wherein the monitoring portion is accessed by a task started periodically on a multitask OS by the processor.

21. The device of claim 1, further comprising a reception packet transfer section for receiving a packet and outputting the received packet to the processor according to an instruction,
wherein the load detection section detects whether or not the processor is in an overload state and outputs the detection result, and
the reception control section stores therein one or more set filter rules, instructs the reception packet transfer section to discard a reception packet matching any of the filter rules and output a reception packet matching none of the filter rules, and when the processor is in an overload state, stores therein a filter rule for use at overloading that allows more packets than in the normal times to match, as the filter rule.

22. The device of claim 21, further comprising an overload remedy section,
wherein the reception packet transfer section notifies the processor of output of a packet,
the overload remedy section determines the frequency of the notification to the processor per unit time, and when the load detection section detects that the processor is in an overload state, notifies the reception control section that the processor is in an overload state if the frequency of the notification is equal to or more than a predetermined value, and
the reception control section stores therein the filter rule for use at overloading, as the filter rule.

23. The device of claim 22, wherein, when the processor goes to a non-overload state from an overload state, the overload remedy section notifies the reception control section that the processor is not in an overload state after a predetermined condition is satisfied, and
the reception control section stores therein a filter rule for use in normal times as the filter rule when receiving the notification that the processor is not in an overload state.

24. The device of claim 23, wherein the predetermined condition is that a predetermined time elapses from the time at which the processor is no more in an overload state.

25. The device of claim 23, further comprising a discard counting portion for measuring the frequency of discarding of reception packets by the reception control section per unit time,
wherein the predetermined condition is that the frequency of discarding is smaller than a predetermined value.

26. The device of claim 21, wherein the filter rule for use at overloading is set to allow all packets to match.

27. The device of claim 21, wherein the reception control section further comprises a statistic acquisition portion for classifying reception packets into a plurality of types and measuring a packet reception frequency per unit time for each type, and
the filter rule for use at overloading is set so that reception packets of types selected in descending order of the reception frequency per unit time, among the plurality of types, match the rule.

28. The device of claim 21, wherein the filter rule for use at overloading is set so that reception packets of a specific type do not match the rule.

29. The device of claim 1, wherein the load detection section detects whether or not the processor is in an overload state and outputs the detection result, and
the reception control section determines the frequency of generation of an event signal generated in relation to packet reception per unit time, and can output a notification signal notifying the processor of reception of the event signal, the reception control section stopping the output of the notification signal if the processor is in an overload state and the frequency of generation of the event signal exceeds a predetermined value.

30. The device of claim 29, wherein the notification signal is an interrupt signal for the processor.

31. The device of claim 29, wherein the reception control section measures the lapse time from the stop of the output of the notification signal, and cancels the stop of the output of the notification signal when the measured lapse time exceeds a predetermined value.

32. The device of claim 29, wherein the reception control section measures the frequency of generation of the event signal per unit time, and cancels the stop of the output of the notification signal when the frequency becomes smaller than a predetermined value after the stop of the output of the notification signal.

33. The device of claim 29, further comprising a watchdog timer for outputting an initialization request signal to the processor when no access is made from the processor within a predetermined time, and
the reception control section stops the output of the notification signal when the remaining time before the watchdog timer outputs the initialization request signal is shorter than a predetermined time.

34. The device of claim 1, wherein the load detection section comprises:
a timer counter for measuring the time elapsed from input of a clear signal and outputting a timeout signal indicating that the measured time reaches a predetermined time as the detection result; and
a monitoring portion for outputting the clear signal to the timer counter when being accessed from the processor.

35. The device of claim 34, wherein the timer counter is configured to allow change of the predetermined time.

36. The device of claim 34, wherein the monitoring portion is accessed by a task started periodically on a multitask OS by the processor.

37. The device of claim 36, wherein the schedule priority of the task started periodically is set lower than the schedule priorities of processing tasks for packet communications protocols and processing tasks for real-time communications applications.

38. The device of claim 37, wherein the schedule priority of the task started periodically is set lower than the schedule priority of processing tasks for real-time control applications.

39. The device of claim 37, wherein the schedule priority of the task started periodically is set higher than the schedule priority of processing tasks for applications requiring no real-time operation.

40. The device of claim 1, further comprising:
a reception packet transfer section for receiving a packet and storing the received packet in a memory according to an instruction, to be ready for output to the processor; and
a packet analysis section for scanning information on reception packets that have been stored in the memory and determining frequency information indicating the reception frequency of the reception packets for each type,
wherein the load detection section detects whether or not the processor is in an overload state and outputs the detection result,
the reception control section comprises:
a discard filter table storage for storing filter rules;
a filter rule setting portion for storing a first filter rule set in the discard filter table storage when receiving the detection result indicating that the processor is in an overload state, the first filter rule set including a filter rule indicating that a predetermined type of packets should be discarded; and
a discard/pass determination portion for instructing the reception packet transfer portion to discard a reception packet matching any of the filter rules and output a reception packet matching none of the filter rules to the processor via the memory,
wherein the filter rule setting portion determines the type of packets to be discarded based on the frequency information determined for the reception packets that have been stored in the memory, and stores a second filter rule set in the discard filter table storage in place of the first filter rule set, the second filter rule set including a filter rule indicating the determined type of packets to be discarded.

41. The device of claim 40, wherein the filter rule setting portion determines the type of packets having a reception frequency exceeding a predetermined value as the type of packets to be discarded based on the frequency information.

42. The device of claim 40, wherein the filter rule setting portion does not determine a given type of packets as the type of packets to be discarded.

43. The device of claim 40, wherein the reception control section further comprises a session management portion for holding information indicating the type of packets used for a communications application that is being executed by the processor,
wherein the filter rule setting portion does not determine the type of packets indicated by the information held by the session management portion as the type of packets to be discarded.

44. The device of claim 43, wherein, when the communications application terminates communications, the session management portion outputs the information indicating the type of packets that were used for the communications application, and
the filter rule setting portion determines the type of packets that were used for the communications application as the type of packets to be discarded.

45. The device of claim 40, wherein the filter rule setting portion changes the second filter rule set so that more types of packets be discarded if receiving the detection result indicating that the processor is in an overload state again within a predetermined time.

46. The device of claim 40, wherein the filter rule setting portion determines the type of packets to be discarded based on the previously-used frequency information if receiving the detection result indicating that the processor is in an overload state again within a predetermined time.

47. The device of claim 40, wherein the reception control section further comprises a learning result storage for storing a threshold,
When determining the type of packets to be discarded based on the frequency information, the filter rule setting portion prepares the second filter rule set using the threshold stored in the learning result storage, and
the learning result storage changes the stored threshold according to the intervals of reception of the detection result indicating that the processor is in an overload state.

48. The device of claim 40, wherein the filter rule setting portion selects a predetermined number of types among the types of reception packets in descending order of the reception frequency based on the frequency information, and determines the selected types as the types of packets to be discarded.

49. The device of claim 40, wherein the reception control section further comprises a queue management portion for holding the number of reception packets allowed to be stored in the memory, and
the filter rule setting portion increases the number of reception packets allowed to be stored in the memory, held by the queue management portion, if receiving the detection result indicating that the processor is in an overload state.

50. The device of claim 40, wherein the reception packet transfer section stores at least header information of reception packets in the memory, and
the packet analysis section scans the header information stored in the memory to determine the frequency information.

51. The device of claim 40, wherein the filter rule setting portion sets the first filter rule set so that all packets be discarded.

52. The device of claim 1, wherein the packet is an Ethernet MAC frame.

53. A semiconductor integrated circuit comprising:
the packet reception control device of claim 1; and
a processor for receiving packets according to the results of determination by the packet reception control device.

54. A packet reception control method for storing reception packets in a memory and then outputting the packets to a processor, the method comprising the steps of:
detecting whether or not the processor is in an overload state;
storing a first filter rule set including a filter rule indicating that a predetermined type of packets should be discarded if receiving the detection result indicating that the processor is in an overload state;
discarding a reception packet matching any of the filter rules and outputting a reception packet matching none of the filter rules to the processor via the memory;
scanning information on reception packets that have been stored in the memory according to the first filter rule set, to obtain frequency information indicating the reception frequency for each type of the reception packets;
determining the type of packets to be discarded based on the frequency information; and
storing a second filter rule set including a filter rule indicating the determined type of packets to be discarded in place of the first filter rule set.

55. The method of claim 54, wherein the step of determining the type of packets to be discarded determines the type of packets having a reception frequency exceeding a predetermined value as the type of packets to be discarded based on the frequency information.

56. The method of claim 54, wherein the step of determining the type of packets to be discarded changes a threshold used for the determination according to the intervals of reception of the detection result indicating that the processor is in an overload state

57. The method of claim 54, further comprising the step of increasing the number of reception packets allowed to be stored in the memory if receiving the detection result indicating that the processor is in an overload state,
wherein the step of scanning information on reception packets scans the reception packets stored in the memory to obtain the frequency information.

58. The method of claim 54, wherein the step of scanning information on reception packets scans header information of the reception packets that have been stored in the memory to obtain the frequency information.
